(19) United States
(12) Patent Application Publication
(10) Pub. No.: US 2006/0095344 A1
(43) Pub. Date: May 4, 2006

(54) System and method for fan lifecycle management

(76) Inventor: Brett A. Nakfoor, Carlsbad, CA (US)

Correspondence Address: MCANDREWS HELD & MALLOY, LTD, 500 WEST MADISON STREET, SUITE 3400, CHICAGO, IL, 60661, US

(21) Appl. No.: 11/313,473

(22) Filed: Dec. 20, 2005

Related U.S. Application Data
(63) Continuation-in-part of application No. 10/320,287, filed on Dec. 16, 2002.
Application No. 10/320,287 is a continuation of application No. 09/590,455, filed on Jun. 9, 2000, now Pat. No. 6,496,809.

(51) Int. Cl. G06Q 30/00

(52) U.S. Cl. 705/26

(57) ABSTRACT

Certain embodiments of the present invention provide a method and system for fan lifecycle management. Certain embodiments of a method for fan lifecycle management include collecting information regarding a ticket for an event and a buyer of the ticket upon sale of the ticket and facilitating sale of product(s) and/or service(s) related to the event based on the information. In an embodiment, information may also be collected regarding a seller of the ticket, for example. The ticket may include an electronic ticket or account information, for example. In an embodiment, information may be electronically collected, and sale of products and/or services may be facilitated electronically. Sale of products and/or services may be facilitated before and/or after the event.

### BACKGROUND OF THE INVENTION

The present invention generally relates to a system and method for sales and distribution of tickets. More specifically, the present invention relates to a system and method for fan lifecycle management before, during, and after an event.

Paper tickets are widely used to grant access to patrons to sporting and general entertainment events. The ticket is a contract which grants the holder the right to attend the event and, normally, to sit in a particular seat. By transferring possession of the physical ticket, a ticket holder has transferred the right to attend the event.

However, many problems are associated with the transfer of paper tickets. In order to issue the ticket, the event promoter must organize the delivery of thousands of tickets. Additionally, if a purchaser wishes to transfer the ticket to a subsequent purchaser, the buyer and seller must be geographically proximate to physically transfer the ticket. With the advent of the Internet, buyers and seller have been able to locate each other in order to transfer tickets. However, the paper ticket still stands as an impediment to the efficient transfer of the right to attend an event because the seller must ship the ticket to the seller. By shipping the ticket the buyer and seller incur additional costs and require a greater lead time to allow the transfer to occur before the event. Each party must also have enough trust that the other party will deliver as agreed. Frequently, because of the impediments of sale, tickets are not widely transferred by geographically remote buyers and sellers. Additionally, there is a need for a system to assist in a transition away from paper tickets.

Another type of impediment stands in the way of the efficient transfer of tickets. Some states have laws which prevent the sale of tickets for more than the face value of the ticket unless the seller has the consent of the event sponsor. To sell the ticket above face value, it is impractical for an individual seller to attempt to obtain permission from an event sponsor prior to selling a ticket. Because an event sponsor makes no money on the transaction, it has very little incentive to grant consent.

In a few other states laws allow a ticket broker to sell tickets at a price above the face value of the ticket, but not buy tickets above face value. Therefore, ticket brokers must obtain a ticket at the face value from the event sponsor and resell the ticket at a higher price. The ticket broker is violating the law if he purchases the ticket at a higher value from someone who is not a ticket broker. Finally, the ticker broker must still physically transfer the ticket to the buyer.

Embodiments of the present invention include a system and method that provide a legal, efficient way to transfer the right to attend an event at the market value of that right and to determine the market value. Embodiments of the present invention eliminate or reduce disadvantages found in the prior art.

In today's market, a paper ticket issues to a buyer for an event. Today's ticket market is very fragmented and presents a buyer with many, different places to purchase different types of tickets. Many choices are inconvenient and confusing to purchasers. Additionally, many ticket purchase options are cumbersome to access and/or use. As a result, buyers are often confused. Furthermore, ticket buyers must search extensively to find the best deal for tickets. Searching for deals often leads to fraud from unscrupulous ticket brokers or other tickets sources. Paper tickets have also been traditionally difficult to transfer from one person to another.

Today's world is a digital one. Airlines, music, photography, radio, telephone, television, and/or other media have become prominent digital areas. Customers are ready to embrace digital solutions. For example, people fly ticketless, use high-speed Internet access, own satellite and other digital television. People own photo-ready and digital telephones, personal digital assistants, and/or personal music players. People are comfortable with digital transactions, and credit and debit transactions have grown to exceed paper-based transactions.

Currently, a ticket is issued, and an organization to which the ticket applies loses an ability to generate additional revenue or capture information from that ticket. Multiple re-sales occur across thousands of marketplaces with almost no information or revenue being shuttled back to the organization or venue. Thus, there is a need for a fan lifecycle management system that may track tickets from issuance to event attendance to post-event data analysis.

An example of a current ticket cycle is shown in FIG. 1. At step 110, a paper ticket is issued. A venue or organization's relationship to the ticket and/or the buyer ends when the ticket is sent. At step 120, the ticket may be resold. However, the organization and the ticket reseller have no knowledge of inventory volume or price points related to tickets for the particular event. At step 130, the ticket is bought. The organization has no knowledge of the buyer and receives no commission from the transaction. At step 140, the ticket buyer attends the game. However, the organization or venue has no relationship with the new attendee at the event. After the event (e.g., after the game), the organization has no way to contact or solicit the unknown fan.

The sports and entertainment world currently operates on paper-based ticketing systems, often selling tickets months in advance of scheduled events. However, the moment a team (or venue) issues a paper ticket to a fan, it loses control of that fan and all subsequent revenue and information that could be collected based on the ticket. Prior to the event for which a ticket is first issued, the ticket may well change hands several times, any opportunity to up-sell the owner is lost, no information can be collected and the fan experience is not maximized.

As a ticket changes hands, often selling for far above its original price, the ticket's new and increased value brings no benefit to the team or venue that originally issued the ticket. Instead, thousands of legitimate ticket brokers (to say nothing for the number of illegitimate scalpers) comprise a fragmented marketplace that shifts billions of dollars a year in revenue away from team and venue owners. In addition, there are numerous cross-selling and up-selling opportunities that do not occur since there is no system to capture not only the people who re-sell and purchase tickets, but also the people who want to get a ticket and are unable to get a ticket. There is no information collected on factors such as price, volume, demographics and econometric data such as weather. Operators remain powerless to partake in new revenue streams due to restrictions in paper-based ticket operations.

Today, paper-based ticket operations allow anyone to purchase a ticket and attend an event anonymously, making it impossible for facility owners and operators to employ proactive security measures involving the identities of event attendees. Attendee identification information is arguably a most efficient security deterrent. Facility owners and operators seeking new security techniques and tools to better prevent, detect and respond to threats to the safety of their fans remain hampered by the anonymity of event attendees.

Simply put, paper-based ticketing does not favor organizations, venues, or fans. Several current providers operate online ticket exchanges but do not offer electronic, rather than paper ticket, solutions. Such efforts are also fragmented and do not provide additional value-added services. Lack of a centralized system leads to misinformation on inventory and pricing and obstructs the collection of information. Additionally, no buyer information is collected, so no data may be analyzed. A paper-based model of anonymous ticket exchange precludes organizations and venues from participating in new revenue streams. Traditional paper-based systems allow various third parties, some of whom may be operating outside of the law, to claim the majority of profits from a secondary ticket resales market. Current systems prevent optimal security because they allow anonymous ticket purchase and access to a large, publicly attended event.

Therefore, there is a need for improved ticketing systems and methods. There is a need for systems and methods providing fan lifecycle management.

### BRIEF SUMMARY OF THE INVENTION

Certain embodiments of the present invention provide a method and system for fan lifecycle management. Certain embodiments of a method for fan lifecycle management include collecting information regarding a ticket for an event and a buyer of the ticket upon sale of the ticket and facilitating sale of product(s) and/or service(s) related to the event based on the information. In an embodiment, information may also be collected regarding a seller of the ticket, for example. The ticket may include an electronic ticket or account information, for example. In an embodiment, information may be electronically collected, and sale of products and/or services may be facilitated electronically. Sale of products and/or services may be facilitated before and/or after the event.

Certain embodiments of the method may further include verifying the information to provide access to the event for the buyer. Certain embodiments further include analyzing the information to generate a recommendation regarding the event.

Certain embodiments of a system for fan lifecycle management include a primary market configured to facilitate a sale of a ticket to a first buyer and recordation of first buyer and ticket information, a secondary market configured to facilitate exchange of the ticket between the first buyer and a second buyer and recordation of second buyer and ticket information, and a value-added subsystem configured to provide product(s) and/or service(s) to the first buyer and/or the second buyer based on the first buyer information and/or the second buyer information. In an embodiment, the fan lifecycle management system may be associated with an organization and/or a venue, for example. The system may facilitate electronic issuance and exchange of paperless tickets, for example. In an embodiment, product(s) and/or service(s) may be provided before and/or after an event related to the ticket.

Certain embodiments of the system may also include a data center configured to store the ticket information, the first buyer information, and the second buyer information. The data center may facilitate analysis of the ticket information, the first buyer information, and the second buyer information, for example. The system may also include an access subsystem capable of granting access to an event related to the ticket based on the first buyer information and/or the second buyer information, for example. In an embodiment, the access subsystem grants access to the event based on an electronic lookup of the first buyer information and/or the second buyer information, for example.

Certain embodiments provide a computer-readable medium having a set of instructions for execution on a computer. The set of instructions may include a ticketing routine configured to facilitate sale of a ticket on at least one of a primary market and a secondary market, wherein the sale includes acquisition of at least one of buyer information and seller information. The set of instructions may also include a services routine for providing products and/or services related to an event, based on the buyer information and/or seller information. The set of instructions may also include an access routine for granting access to the event based on the buyer information. In an embodiment, the service routine further provides products and/or services related to the event before the event and/or after the event, based on the buyer information and/or seller information. In an embodiment, the ticketing routine is configured to facilitate electronic sale of the ticket, and the access routine is configured to grant access to the event based on electronic verification of the buyer information.

Certain embodiments of a fan lifecycle management system include a data center storing fan lifecycle management data. Data may include electronic data related to ticket sellers and/or ticket buyers, for example. The data is used to facilitate electronic ticket sales, secondary market electronic ticket exchanges, sale of value-added products or services provided prior to an event, and sale of value-added products or services provided after an event. The data center may extract the electronic data related to ticket sellers and/or ticket buyers from primary market and secondary market ticket transactions involving the ticket sellers and the ticket buyers. In an embodiment, value-added products and/or services may include pre-paid parking, concessions, merchandise, ticket offers, tailgating services, event cancellation insurance, fan loyalty programs or affinity programs, any travel packages, games, fantasy-type games, etc., for example.

### BRIEF DESCRIPTION OF SEVERAL VIEWS OF THE DRAWINGS

FIG. 1 illustrates a flow diagram for a prior art ticket usage cycle.

FIG. 2 illustrates a flow diagram for a method for fan lifecycle management in accordance with an embodiment of the present invention.

FIG. 3 illustrates a flow diagram for a method for fan lifecycle management used in accordance with an embodiment of the present invention.

FIG. 4 illustrates a transaction flow diagram for fan lifecycle management used in accordance with an embodiment of the present invention.

FIG. 5 illustrates an example of a fan lifecycle management (FLM) system used in accordance with an embodiment of the present invention.

FIG. 6 is a diagram of an electronic ticketing system according to an embodiment of the present invention.

FIG. 7 is a diagram of a data center according to an embodiment of the present invention.

FIG. 8 is a diagram of a venue according to an embodiment of the present invention.

FIG. 9 is a flow chart describing the steps of a ticket lifecycle according to an embodiment of the present invention.

FIG. 10 is a flow chart of a method for ticket owner authentication according to an embodiment of the present invention.

FIG. 11 shows an electronic ticketing and access system used in accordance with an embodiment of the present invention.

FIG. 12 illustrates a method for multi-input access to a venue used in accordance with an embodiment of the present invention.

FIG. 13 illustrates a flow diagram for a method for access verification inside a venue in accordance with an embodiment of the present invention.

FIG. 14 illustrates an example of a user inventory interface used in accordance with an embodiment of the present invention.

FIG. 15 depicts an interface screen showing tickets that a particular user currently has for sale in accordance with an embodiment of the present invention.

FIG. 16 depicts an example of an interface view allowing a user to view an inventory of tickets or other products and services that the user has sold in accordance with an embodiment of the present invention.

FIG. 17 illustrates a view allowing users to see detailed information on what tickets were sold, where the tickets were located, and fee(s) associated with that sale in accordance with an embodiment of the present invention.

FIG. 18 depicts an exemplary view allowing users to see what tickets were transferred and fee(s) associated with that transfer in accordance with an embodiment of the present invention.

FIG. 19 shows a view providing detail regarding a purchased ticket in accordance with an embodiment of the present invention.

FIG. 20 shows information regarding the tickets that are actively listed in a ticket exchange in accordance with an embodiment of the present invention.

FIG. 21 shows an interface allowing a seller to modify offered tickets, view any bids that are currently on the offered tickets, and/or use the “Sell Now” button in accordance with an embodiment of the present invention.

FIG. 22 depicts a view that shows all of a user's bids in accordance with an embodiment of the present invention.

FIG. 23 illustrates an example of an interface for viewing account activity on a particular account in accordance with an embodiment of the present invention.

FIG. 24 shows an example of an interface used to view payment options for a particular user and/or venue in accordance with an embodiment of the present invention.

FIG. 25 illustrates an example of an introductory interface screen that lists participating and/or available organizations in accordance with an embodiment of the present invention.

FIG. 26 shows an exemplary interface allowing a buyer to view events for a team and select an event to find tickets in accordance with an embodiment of the present invention.

FIG. 27 illustrates an exemplary interface allowing a buyer to view tickets for sale for an event in accordance with an embodiment of the present invention.

FIG. 28 illustrates an exemplary interface allowing a buyer to make a bid for tickets in accordance with an embodiment of the present invention.

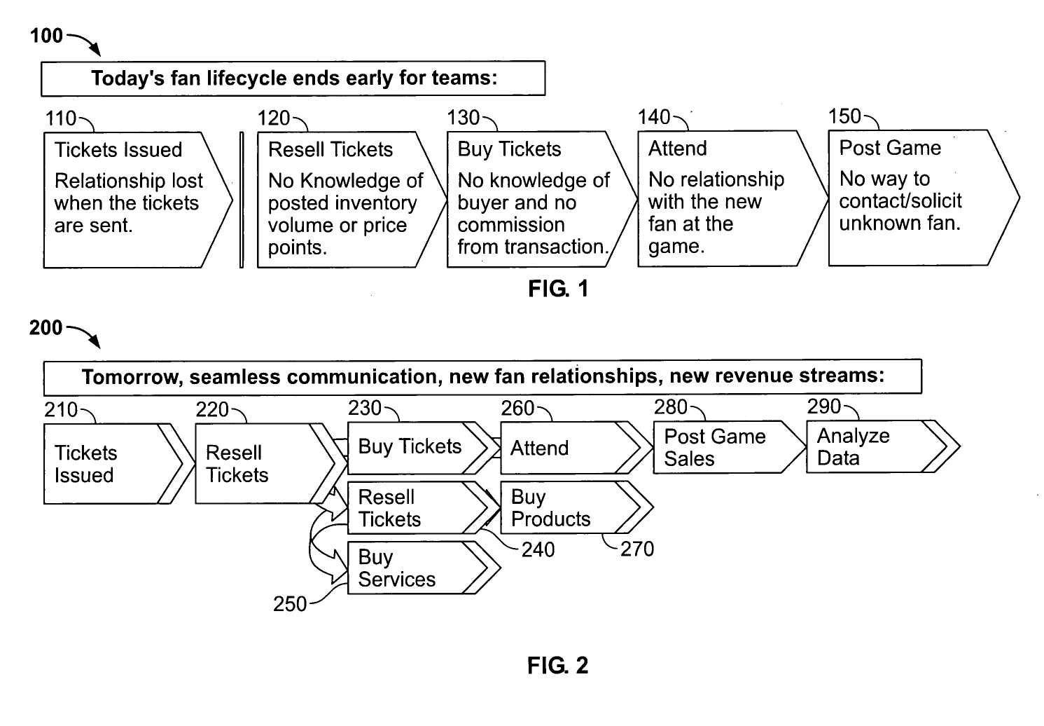

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments provide fan or other customer lifecycle management (FLM) methods and systems for management of a variety of aspects of a patron's interaction with an event and/or organization. Certain embodiments of FLM methods and systems relate to a lifecycle or flow of events for a customer in relation to one or more events and/or venues. FLM covers flow of information and activity from ticket issuance; ticket re-sales and transfers (both paper-based and paperless), including exchange trading functionality (e.g., options, re-sales, transfers, what-ifs, bundling, swaps, seat upgrades, etc.); value added products and services (such as pre-paid parking, merchandise and concessions, loyalty programs, donations, up-sales and cross-sales); event entry and attendance; post-event transactions (including sales, products, services, etc.); and data analysis of touch point(s) and/or other data in the fan/customer lifecycle, for example.

Ticket issuance includes all forms of issuing a ticket, whether paper or non-paper (electronic), for example. Tickets may include, but are not limited to, electronic tickets (e-tickets) of any kind, including e-tickets issued to wireless or mobile devices, radio frequency identification, tickets held in electronic form and printed later, e-tokens on smart cards, biometric identification, and/or any solution used to allow human beings to enter an event or venue. Tickets may also include standing room only (SRO), last minute ticketing, and tickets that have been issued.

Tickets may be issued electronically and/or may be issued as physical tickets and exchanged for electronic tickets. Alternatively, physical tickets may be used to access a venue. Electronic tickets may be stored as records in a database or other data store, for example. Electronic tickets may be associated with authentication data for a customer, such as a credit card number, an identification card, a driver's license, a membership number, etc. An electronic record and/or authentication data may be checked for access to a venue, for example.

Ticket issuance may also include various methods of ownership, including but not limited to syndication, buyer groups, time shares, buddy lists or user groups. For example, a group of individuals may pool their resources in a syndicate or buyer group to buy season tickets which cost as much as $18,000 per seat. Once tickets are transmitted, the tickets are split up and sent to each participating individual. Also, buddy lists or user groups might be set up so that specific persons are designated by ticket owners to facilitate transfers or re-sales to those designees. For example, a buyer or buyer group purchases season tickets. After the season starts a transfer fee is charged if the ticket is sent to another person. By setting up a buddy list before the season starts, ticket owners may designate specific persons, such as family members, to whom tickets may be transferred at no charge. In another example, a time share or user group may be established. A group of individuals may purchase season tickets and not designate specific games for each user. Instead, each user has a number of credits that may be used for tickets. When those credits are exhausted, that user may no longer use that group to attend games.

In an embodiment, tickets may be held back and sold directly into a secondary market as a ticket issued. For example, tickets for a game between the Boston Red Sox and the New York Yankees may not be included in a season ticket package and are instead auctioned to potential purchasers. That is, a ticket is issued by allowing bids to be placed in a secondary market exchange, and the ticket is sold directly into the secondary market at a higher price. As another example, the Red Sox may auction the Yankee tickets in a separate package before the season starts, but each individual game ticket is sold close to the actual game date (e.g., 1-3 weeks before each game). For instance, tickets might be sold “on demand” directly into the secondary market. After seeing what true demand is, organizations may sell smaller packages or games directly into the secondary market. In certain embodiments, electronic tickets facilitate easy sale in the secondary market.

Fan lifecycle management also includes a secondary market exchange for transactions including buys, sells, transfers, options, what-ifs, swaps, bundled sales, upgrades, etc., of any sort for event tickets or venue access. A fan lifecycle management system and/or method may track any transaction or change of record, ownership or possession of ticket(s) from one person to another, for example. Additionally, trade of options, such as put or call options on original ticket prices and/or put or call options on prices in the secondary market exchange, may be facilitated via the secondary market.

In an embodiment, the secondary market includes parameters or characteristics, such as bidding schema, pricing schema, market ordering techniques, etc. Market ordering techniques may include bundling, section wide bids, row wide bids, market-if-touched, order-cancels-other, fill-or-kill, at market sells or buys, spreading strategies, auto selling (automatic selling after a time period if a minimum price is available), and/or auto bidding, for example. For example, automatic bidding is bidding or buying that is triggered when a specific price is met. For instance, if a user's current bid is $35, an auto bid may be entered at $50-$70 such that that if the bid price reaches $50 due to another bidder, a higher bid of up to $70 may automatically be entered for the user.

By using the order-cancels-other technique a potential buyer may have 2 or more bids in a particular game. One bid may be $100 each for 2 tickets in the 100 section, another bid for the same game might be $60 each for 2 tickets in the 200 section. The potential buyer is indifferent to which tickets are purchased but is very interested in attending the game. As soon as the order for the tickets in the 200 section are filled or purchased, the order for the tickets in the 100 section is automatically cancelled.

Fill-or-kill may be described as an order to sell or buy being entered into the system for a period of time, usually a short period of time. Either the transaction occurs in that period of time, or the system automatically cancels the order. For example, a seller has 2 tickets for a game and is deciding whether or not to attend the game. The seller decides to see where the market is trading and offers 2 tickets for sale at $80 per ticket for a period of 2 hours. If a buyer is found, the order transacts. If not, the order is cancelled automatically by the system.

A market-if-touched order is for a buyer or seller who has an existing bid or offer in the exchange. As an example, a buyer is willing to pay $50 for a ticket and has entered a bid. The same buyer is willing to pay up to $100 for the ticket but does not want to start at that price. If a seller enters the market at a price anywhere between $50 and $100, the ticket will automatically transact. In this example, a seller sees the bid at $50 and enters an offer of $85. The system recognizes the offer, and automatically purchases the ticket for $85. An example of a market-if-touched order for a seller is listing a ticket for sale at $100 but having a seller that would be willing to take $50. In this instance, a buyer enters a bid of $65, the system recognizes that bid and automatically sells the ticket that was listed at $100 for $65 to the new buyer.

A section wide bid offers the ability to provide unsolicited bids to ticket holders. A potential buyer desires to attend a game and is willing to pay a specific price or price range. By utilizing the section wide bid feature the buyer may choose a section or sections and offer a price for any seat in that section. This information is sent out to all ticket holders in that section, and, if any ticket holder sells their ticket to that bidder, the order is then complete. A row wide bid facilitated in the same fashion with the exception that it is a row and not a section. An example of bidding or price schema may be any type of auction or reverse auction, any bid/ask market, or any other schema or technique used to price tickets, for example.

In an embodiment, the FLM system and method facilitate spreads. A spread typically involves buying one ticket or commodity and selling another. Spreads may also be more complex and involve options or more than one buy and sale. An example of a more complex option may be a butterfly spread which would involve buying 2 tickets and selling 2 tickets. By providing arbitrage opportunities in different market(s), an overall risk of a particular trade may be limited. For example, a user might think that Detroit Tiger tickets are going to increase in value and Milwaukee Brewer tickets are going to decrease in value. The buyer purchases Tiger tickets and sells Brewer tickets. In another example, a buyer might purchase tickets for a Tiger game against the Yankees game, since tickets for that game will most likely be in high demand, and sell Tiger tickets for the Marlins game, a low demand event. In both cases, the differential between the buys and sells make a spread, and, based on rising or falling prices, that spread could increase or decrease in value. A separate market may be created that trades spreads, or the buyer may hold the tickets in their account and trade out of each ticket individually. Additionally, as a function of the exchange, the FLM system may set price floors or ceilings for tickets or items or allow users to set price floors and/or ceiling. A price floor prevents a ticket from selling at less than a specified minimum. A price ceiling prevents a ticket from selling at more than a specified maximum. In an embodiment, the FLM system may implement any of a plurality of algorithms that are used to create pricing, forecasting, volume determinations, etc.

A function of the exchange may also include a “what-ifs” or a “what-if” market that is similar to an option, but buyers and sellers determine pricing based on “what-ifs”. For example, a buyer might be willing to pay $50 to purchase the right to purchase a predetermined ticket price “if” the Detroit Lions reach the Super Bowl. If the Lions reach the Super Bowl, then the buyer has the right to purchase a ticket at a predetermined price. If the Lions do not make the Super Bowl, then the $50 is forfeit. Thus, the market may rise and fall based on a number of wins and losses for each team in the “what-if” marketplace.

A function of the exchange may also include swaps or a swap market. An example of a swap may be one ticket holder selling their ticket for another ticket plus cash compensation. For example, a ticket holder A holds a seat in the 100 section and ticket holder B holds a seat in the 200 section for the same game. By entering into the swap market or into a swap transaction, ticket holder A gets ticket holder B's 200 section seat plus $100 and ticket holder B gets the seat in the 100 section. Both ticket holders attend the game but they have swapped seats and other compensation with each other. The compensation for the swap does not have to be cash. Compensation may be additional seats or any other form of compensation that the parties deem appropriate.

Fan lifecycle management (FLM) may provide a variety of additional services. For example, FLM may facilitate bundling, which includes selling a group or bundle of tickets at once (e.g., a season ticket package, all Sunday games, all games against a particular opponent, etc.). Bundling may also include combining tickets to an event with other services and/or options (e.g., food, souvenirs, parking, hotel, etc.) related to the event, for example. FLM may also generate notifications via a plurality of media, including email, text messaging, wireless, phone or fax, which lets exchange participants know if specific market conditions have been met. Additionally, FLM may deliver notification to a current ticket owner that a buyer is willing to pay for a ticket that is not currently for sale (i.e., an unsolicited bid). For example, the FLM secondary market exchange may announce that a potential buyer is looking for NCAA Final Four basketball tickets. Registered users may receive a notification and/or an announcement may be posted to a web page, bulletin board, etc., to invite offers for sale and/or facilitate ticket transactions.

In an embodiment, FLM may also facilitate purchase or upgrade from one seat in a venue to another. For example, a ticket holder at an event in the 300-section (upper level) of a venue sees empty seats in the 100-section (lower level) and pays a fee to become a ticket holder of record for a seat in the 100-section. Alternatively, upgrades may be purchased in advance based on availability. In an embodiment, tickets may be swapped or traded via an FLM secondary market. Alternatively, a ticket may be traded for another ticket, cash, and/or other compensation. For example, a 300-section ticket holder is willing to pay $200 plus his ticket for a seat in the 100-section. The 100-section ticket holder receives cash and is still able to attend the event in a different seat (the 300-section seat).

The secondary market exchange may also include value maximization or “find best”, pairing of tickets or options, predatory selling and/or syndicating re-sale, for example. Value maximization or “find best” allows the system to search for specific parameters, assemble those parameters and present a potential buyer with those parameters, similar parameters or different options. For example, a buyer may be willing to pay $400 for 2 tickets in the 100-section, but does not know if those tickets will be available at that price. The buyer may use a “find best” option and have the system search for the best available other option. The FLM secondary market system may search and locate 4 tickets in the 200-section for $400. The buyer is then notified of the tickets. Find best allows the potential buyer to set parameters, have the system find the best available tickets and present those options to the buyer. Find best may also be used for a seller to set the best prices and/or times to sell a ticket, for example.

The secondary market exchange may provide pairing of tickets by allowing tickets to be sold in allotments that a seller specifies. For example, a seller may list 4 tickets for sale but specifies that the tickets are for individual sale. Additionally, a buyer may set parameters to purchase in specific amounts. Pairing functionality may also be applied to options and/or other items/services for sale on the secondary market.

In an embodiment, a buyer or seller may bid or offer a quantity of tickets for a period of time. For example, a seller may offer four tickets for sale only if he/she may receive a good price for the tickets. The seller may offer the tickets to the market for a certain period of time (e.g., six hours), at a certain price or price range. If a buyer is willing to meet the price within the time period, then the tickets are sold. Otherwise, the tickets are not sold. Similarly, the buyer may offer to buy a certain number of tickets (e.g., four tickets) for a certain price or price range. If a seller matches the buyer's price or the desired number of tickets are available for the desired price, then the buyer buys the tickets. Otherwise, the buyer does not make a purchase.

Predatory selling prevents someone from purposely bidding up the price of a ticket in order to trigger a market-based order. The FLM secondary market exchange may be configured to prevent or minimize predatory selling practices. Syndicating re-sale allows groups of buyers to purchase one or more tickets, designate owners of record, allow for financial reconciliation, form buddy lists, set buyer groups, etc.

The fan lifecycle management architecture may also be used to provide a variety of value added products and services. Product and services may include Value Added (VA) products and services that are created from a ticket sale, re-sale, transfer or other exchange, or by identifying a prospective seller or buyer, for example. VA may also include pre-paid parking, merchandise, or concessions. Additionally, event cancellation insurance or protective services, such as rain checks, rebates, etc., may be provided via FLM. Services, such as rescheduling management, lottery, sweepstakes, raffles, and/or promotions, based off inventory or information from the FLM system, may be provided. For example, an organization may provide complimentary tickets for raffle or promotion through a web site or other medium.

Cross-selling and up-selling may occur also. For instance, a buyer just purchased tickets to a U2 concert for $200 per ticket. The FLM architecture may up-sell that buyer with offers for U2 CDs or DVDs, for example. The FLM architecture may also cross-sell that buyer by recommending tickets that are for sale for artists in a similar musical genre, for example. Cross-selling or up-selling may also include any VA product such as pre-paid parking, merchandise or concessions.

In an embodiment, a program that tracks information and compiles points and/or rewards, such as a fan loyalty or affinity program, may be implemented to run across all aspects of FLM from ticket issuance to data analysis. For example, the FLM system may track buying behavior and allow a customer to accumulate points and/or rewards for later redemption and/or discount. Tailgating services created using FLM information, such as prepaid tailgating locations, food and beverage delivery, on-site gourmet food, corporate outings, etc., may also be provided. Additionally, FLM may provide a travel package, for example, created using information in the FLM system. For example, a travel package may include determining a location of a buyer or seller purchasing a ticket, arranging flight, hotel, car and/or other travel packet around the location.

FLM may provide games to a user of the system. For example, fantasy sports games and/or other games may be created using FLM information. Broadcast and/or streaming video may be provided in relation to information in the system. Seat upgrade packages may also be offered via the FLM system. Cross-sell and/or up-sell capability may be offered. FLM may also share information regarding sales of products and/or services for help with event planning. For example, a certain amount of pre-paid concessions may be sold via the FLM system, and that information is shared with another company that manages the concessions at the event. That company then plans their inventories, etc., based on that information.

A fan lifecycle management system may facilitate entry into an event in connection with information gathered in the FLM system. An access control device, such as a multi-input turnstile, scanner, or other access device, may be used to gain entry to a venue in conjunction with the FLM system. Fan lifecycle management may include generation of a seat receipt or printed ticket in connection with access to the event. Additionally, security and/or fraud prevention may be used in connection with information from the FLM system to grant access to a venue. Furthermore, security monitoring may be created using FLM information. For example, information, such as name, address, payment information, Social Security number, etc., may be collected and shared with governmental agencies that provide cross-checking against watch lists. Thus, transactions may be monitored in real-time to enhance security at an event.

After an event, FLM may facilitate follow-up and/or provision of further products, services, cross-sells and/or up-sell to patrons. For example, information regarding who bought tickets, who sold tickets, who tried to sell but was unable to sell, and/or who tried to buy but was unable to buy may be collected in the FLM system. Using the information, products and/or services, such as DVDs, CDs, audio content, video content, framed commemorative tickets with photos from the event or other memorabilia, merchandise, jerseys, future tickets, other content, etc., may be marketed to a desired audience.

FLM may also be used to perform data analysis. Analytical data collected from the FLM system may be processed to determine usage statistics and other trends. Usage data may help improve other FLM processes. Data may also be used in forecasting, reporting, etc. Data may also be used to compile statistics such as ticket inventory turn, attendance information, buys, sells, price, volume, transfers etc. Furthermore, data may be used for monitoring, such as listing which original purchasers bought and sold and how often purchasers have bought and sold, compiling past history pricing and volume information, tracking how often specific tickets changed hands or were re-sold, identifying what percentage of a venue was re-sold, compiling graphs and charts, and/or tracking a specific user's or specific account's past history of sales, buys, prices and providing that information to said user in the format of their choice, charts, graphs, etc. Data may also be used to help a team, venue or organization determine how many tickets to pre-sell, or sell as season tickets and how many tickets they can expect to sell directly into the secondary market exchange. This analysis can help teams determine an optimal sales strategy for an event to help increase their profit. Data may also be used in determining no-show rates, tracking fan spending inside an event such as merchandise and concessions, using historical data to set next year's ticket prices, monitoring econometric data such as weather and how it factored into event attendance and sales, providing and compiling demographic information regarding who bought, who sold, who entered a bid but did not buy, who offered a sale and did not sell, where those people are located and how often they use or attempt to use the system, etc., and/or any other data mining report or statistic that may be determined from data within the system.

In an embodiment, yield management or price discrimination may be determined from data analysis collected in FLM. For instance, tickets may be priced at $40 in two specific sections. However, upon data analysis of the FLM, one section had an average re-sale price of $58 ticket, and the ticket prices may be raised for the next year. Another example might be a row of tickets has the same price of $40/ticket but specific seats trade higher or lower and therefore are issued at a different price the next year.

Yield management may also be classified as a compilation of statistics over time or forecasting. For example, an organization may examine five years of using a secondary market exchange and compare many variables (such as team performance, specific performance statistics, and econometric data, such as weather, local economy, demographic trends, inflation rates, secondary market prices and volume, etc.) and determine new ticket packages, ticket prices and/or methods of selling tickets. Organizations may forecast primary market ticket prices based on past information, similar events, secondary market prices, etc. A multitude of forecasting techniques may be used.

Thus, fan lifecycle management allows tickets to be issued, sold, exchanged (e.g., transferred re-sold, what-if, option, etc.), cancelled, re-issued, etc. For example, if a ticket is traded between individuals, in order to comply with laws in certain jurisdictions, the ticket may be cancelled and a new ticket re-issued at a higher price or a higher face value. In an embodiment, a ticket may be issued with a price range rather than a specific price. For example, a new ticket may be re-issued with a suggested price between $60 and $10,000.

FLM may be used as a planning tool for an organization. FLM information, such as pricing, volume, demographics, etc., may be used to plan events with more precision and improve monetary savings and increase revenue. FLM information regarding buyer information, seller information, etc., allows a venue or organization to sell value added services, perform data analysis, etc.

In certain embodiments, FLM serves as an exchange facilitating a variety of transactions involving tickets, products, and/or services. The FLM exchange allows a variety of trades and/or other transactions, including bid-ask, auction, options, swaps, what-ifs, auto-sells, fixed-price sells, etc. Operating under an exchange model allows an FLM system to accommodate a wide variety of operations involving tickets and related products and/or services, for example.

FIG. 2 illustrates a flow diagram for a method 200 for fan lifecycle management in accordance with an embodiment of the present invention. The method 200 helps to facilitate communication, new fan relationships, and/or new revenue streams related to ticket sales and event attendance. First, at step 210, ticket(s) are issued. Then, at step 220, tickets are offered for resale and/or other exchange. Tickets may be offered for resale and/or other exchange at a venue and/or in an electronic secondary market, for example. Next, at step 230, ticket(s) may be purchased by a secondary buyer. In an embodiment, at step 240, ticket(s) may be resold again to one or more subsequent buyers. At step 250, a ticket holder may buy services related to the ticket, the event, the venue, the organization, and/or other information, for example. At step 270, a ticket buyer may purchase additional product(s) related to the ticket, the event, the venue, the organization, and/or other information, for example.

At step 260, an event is attended using the tickets. Following the event, at step 280, post game sales may be facilitated using buyer and/or seller information, for example. Then, at step 290, data relating to information, such as ticket transactions, event information, value added sales information, buyer information, and/or seller information, may be analyzed to generate reports, recommendations, trends, etc.

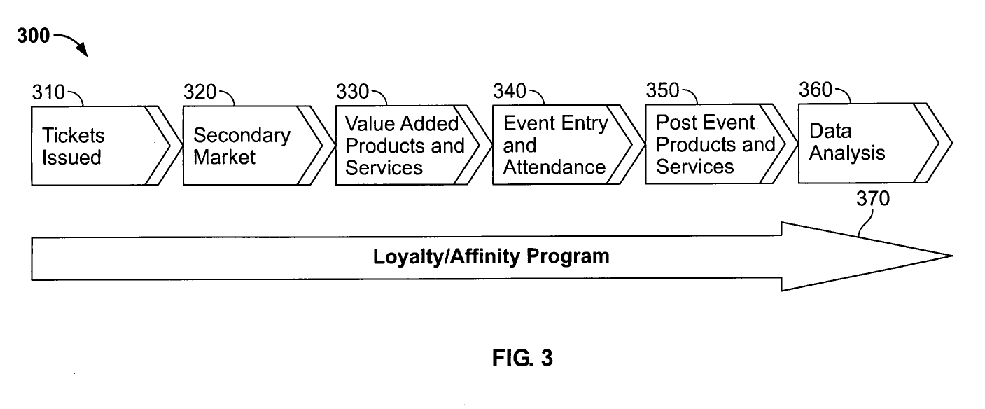

FIG. 3 illustrates a flow diagram for a method 300 for fan lifecycle management used in accordance with an embodiment of the present invention. At 310, tickets are issued to original purchasers. Then, at 320, a secondary market is provided to allow exchange (e.g., resale, transfer, options, what-ifs, etc.), and/or supplemental transactions regarding the tickets. At 330, value added products and/or services may be provided to ticket buyers and/or sellers based on information gathered during the course of primary and secondary market sales. Value added products and services may be provided in advance of an event to provide a ticket holder with additional options related to the event (e.g., memorabilia, extra services, food and beverage orders, etc.). Alternatively, value added products and services may be provided after an event.

At 340, an event occurs, and a ticket holder enters the event using the purchased paper or paperless ticket. Then, at 350, post event products and/or services may be provided. For example, memorabilia, related tickets, future tickets, other offers, etc. may be offered to people who attended an event, who wanted to but could not attend the event, and/or people who sold their tickets to the event. Post event products and/or services may build upon a patron's experience and/or interest in the event to encourage purchase of other goods and/or services. At 360, data analysis may be performed regarding fan lifecycle management statistics, usage statistics, purchasing statistics, and/or other data. In an embodiment, data may be captured throughout fan lifecycle management at 370 for use in a loyalty/affinity program. For example, customer purchase, sale, and/or other activity data may be used to provide points, rewards, and/or other incentives to repeat and/or otherwise valuable customers.

A fan lifecycle management system and method create a centralized market/exchange or distributed market(s)/exchange(s) for ticket resale and/or other exchange, eliminating street scalpers, ticket brokers, and other online marketplaces. FLM allows organizations access to information, such as event attendees, individuals unable to purchase a ticket, attendee spending, etc. Data from electronic and/or paper-based tickets may be used to manage and monitor an entire fan lifecycle. An FLM system provides a centralized exchange for the real-time sale and distribution of electronic tickets, comprehensive data mining, pre-paid parking, merchandise and concessions, partner products, an/or post-event collectibles and content, for example. The centralized FLM exchange may assist organizations and venues in efforts to improve patron experience, increase revenues, and/or collect data on a customer base. In an embodiment, the FLM system and/or venue may charge transaction fees to ticket buyers and/or sellers for each transaction facilitated using the FLM system. The FLM system may also charge users for report fees and/or advertising fees, for example.

In certain embodiments, discontinuing proliferation of physical tickets in favor of electronic tickets facilitates many benefits. In the absence of paper tickets, the secondary market may be consolidated into a centralized exchange—a single location to which fans may access to search for, buy and sell tickets. This exchange creates maximum liquidity, returning to teams and venues complete control of the secondary ticket market and maximizing market conditions for the benefit of buyers and sellers. Numerous opportunities to cross-sell and up-sell may be realized, precise data may be collected and the lifecycle of a fan or other event patron may be managed at every point, creating a new way to interact with customers. Additionally, fan/customer experience may be improved and more convenient.

Using a fan lifecycle management system and method, customers have a more convenient way to re-sell, transfer, or purchase tickets, and to purchase and acquire parking, merchandise, and concessions. For example, fans at a sporting event may purchase pre-paid parking, merchandise and concessions at a stadium and have access to many complementary services for the event. FLM may allow venues to create tie-ins to strategic partners allowing a customer to make travel arrangements and purchase products such as commemorative items when buying tickets. In certain embodiments, a centralized exchange and/or other similar exchange for the secondary market holds 100% of the inventory and allows for accurate, real-time data. A secondary market sanctioned by venues and organizations may help provide peace of mind to customers and venues, allowing customers to buy and/or sell in confidence.

An electronic exchange reduces customer and venue expense by eliminating mail or transfer of a physical ticket. An electronic ticket exchange provides an ability to transfer or gift tickets or related merchandise to family or friends instantly. Additionally, online electronic transactions reduce or eliminate time spent waiting in line to purchase tickets, concessions, merchandise, etc.

Using a centralized secondary market allows organizations and venues to reduce or eliminate scalpers and third party brokers working against the interests of teams and venues. Organizations and venues may realize increased revenue from previously unavailable revenue streams, such as secondary market commissions, pre-paid parking, merchandise, concessions, and partner products. Additionally, increased ease and timeliness of ticket transfers may increase event attendance (and decrease waste of unused tickets). FLM allows purchase of post-event items and content, such as video, audio, and/or other collectibles or memorabilia. Using information collected at the ticket exchange, venues and organizations may identify to whom to advertise and sell the goods.

By accessing information captured during the lifecycle of a fan and/or other customer (e.g., inventory turnover, price and volume data, demographic and econometric information, etc.), business decisions regarding, for example, ticket pricing and/or marketing may be made more intelligently. Venues may also reduce costs associated with ticket printing and distribution and with staff dedicated to season ticket administration, ticket taking, access point monitoring, and/or other event services. Security initiatives and compliance may also be improved using real-time data stored in relation to tickets. Data acquisition and verification through FLM may help to reduce fraud and heighten event security.

In an embodiment, FLM may be provided to organizations and venues through a private extranet web site or portal. General public may access the FLM system and method using a public web site or portal (e.g., a secure web site), for example. Using one of a plurality of interfaces (e.g., a computer, a mobile phone, a fixed-line phone, a personal digital assistant, etc.), a customer already possessing electronic tickets may, for example, put tickets up for sale, set preferences associated with ticket sales (e.g., asking price, sell-by date, alerts/notifications, etc.), and/or manage current ticket inventory and purchase additional products/services.

A customer interested in finding and purchasing tickets may, for example, input information (e.g., team, performance, location, and/or venue data) to narrow their ticket search to a single event. Then, the customer may select from available seats for that event (e.g., search by price, location, specific number of sequential seats, etc.). The customer may order pre-paid parking and/or concessions and purchase selected tickets as well as pre-paid parking, merchandise, and/or concessions using a credit card, online bank or credit account, membership, and/or other identification, for example. In an embodiment, a customer may also be able to fulfill travel requirements via the FLM portal.

An organization (e.g., a team, university, music producer, music group, theater producer or show, etc.) and/or event venue (e.g., a stadium, an arena, a theater, a convention center, etc.) may access a secure intranet customized for the organization/venue, for example. In an embodiment, the FLM system may be accessed directly through a web browser, an FLM interface, a hosted software service, and/or Application Service Provider (ASP), for example. Alternatively or in addition, FLM may be accessed indirectly through an enterprise software ticketing module or other such system, for example. An organization or venue may access real-time and/or historical data to, for example, upload season ticket (or other primary ticket) sales data, including event date/time, seat number, face value, sales date, ticket holder identifying information, etc. An organization and/or venue may determine attendance at any point up to and during an event. Preferences may be configured so as to generate reports for viewing historical data related to attendance, revenue, “no-shows”, pre-paid concessions or other merchandise and/or services, etc.

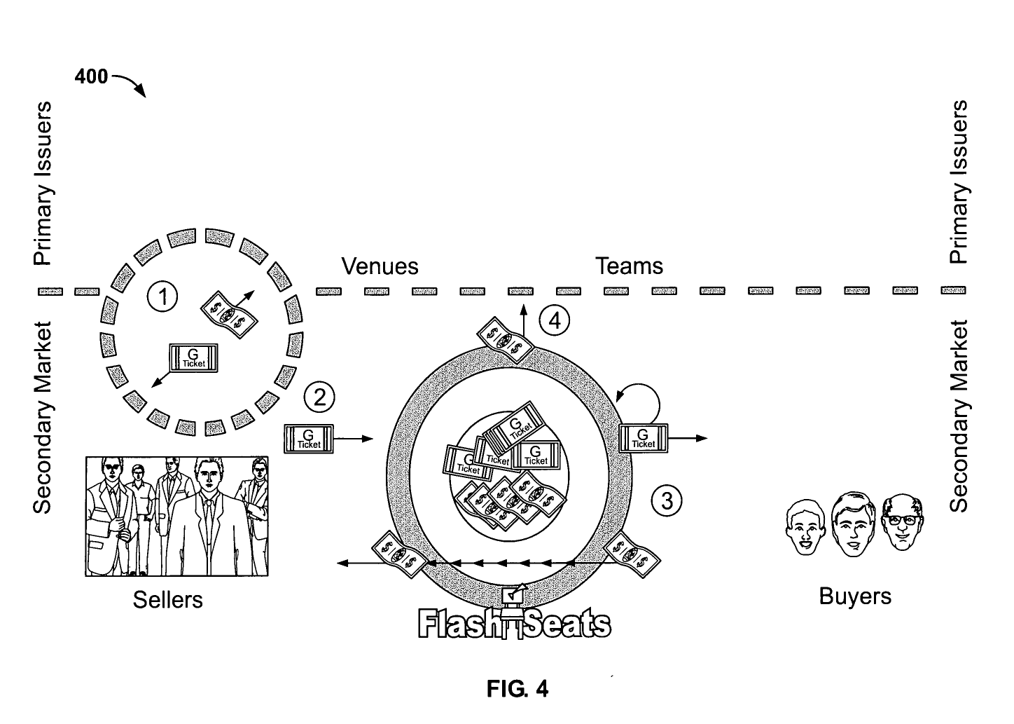

FIG. 4 illustrates a transaction flow diagram for fan lifecycle management 400 used in accordance with an embodiment of the present invention. In a first transaction, a fan buys an electronic ticket for full face value (e.g., $30) direct from a team (or through a primary ticketing partner, for example). A data abstract is pushed to an FLM centralized exchange identifying the fan and the associated ticket information. The fan may use the electronic ticket for admission to the event. Alternatively, in a second transaction, the fan elects to sell the ticket. The fan (i.e., seller) lists the ticket on the FLM exchange for an asking price (e.g., $100). When the ticket sells, an amount is credited to the seller's credit card or other electronic account, for example. The exchange and/or team may charge a percentage or set transaction fee for the ticket resale (e.g., when the ticket sells, $87.50 is credited to the seller rather than $100).

In a third transaction, the fan (i.e., buyer) accesses the FLM online exchange to purchase a ticket. The fan searches, locates, and buys a ticket (e.g., the ticket with the asking price of $100) using a credit card or other electronic account. In an embodiment, a transaction fee is added to the ticket charge for the buyer (e.g., $112.50 is charged to the buyer's credit card). In a fourth transaction, if transaction fees have been added to the sale and purchase of the ticket (e.g., $25 in transaction fees), the profit from the transaction fees is split between the FLM exchange and the team and/or venue.

To enter an event, a fan simply swipes his/her credit card, (or other magnetic-striped or electronic form of identification), or uses a wireless phone or device, radio frequency device or some other electronic form of identification at properly equipped turnstiles or other access devices. The FLM system matches the fan's identity with his/her electronic ticket(s), comparing it to data stored in the FLM system. The FLM system may include an onsite server (e.g., a synched, redundant server) to insure fastest possible processing. Using an electronic process, confirmation may be provided in real time and a receipt with detailed seat assignments and/or access restrictions may be generated.

A fan lifecycle management system may be implemented in hardware, software, and/or firmware in a variety of integrated and/or separate configurations. The FLM system may be implemented on a computer, such as a personal computer, server, web server, mainframe, and/or other computing device. The FLM system may be accessed using a web browser, graphical user interface, text-based user interface, ticketing manager, ASP, and/or other custom interface, for example. Certain embodiments of the FLM system and method may be implemented as a set of instructions or routines stored on a computer-readable medium, for example. In an embodiment, a fan lifecycle management system may be provided as a hosted process available via a web browser and/or other portal or interface, for example. For example, FLM may be a hosted software service accessible via a computer, a wireless device, and/or any instrument capable of connection to the Internet or other network. Purchasing, trading, reporting, inventory, account status, and/or other information/functionality may be accessible to a customer and/or organization via an interface or access point, for example.

For example, FLM may be implemented as a ticketing routine configured to facilitate sale of a ticket on a primary market and/or a secondary market. The ticketing routine acquires buyer, seller, and/or ticket information at the sale of the ticket. A services routine may be configured to provide products and/or services related to an event and/or venue based on the information acquired by the ticketing routine. Products and/or services may be provided before and/or after the event, for example. An access routine may grant access to an event/venue based on the buyer information. Access may be granted electronically based on buyer credit card information, driver's license information, electronic account information, etc., and/or by scanning or other presentation of a paper ticket, for example.

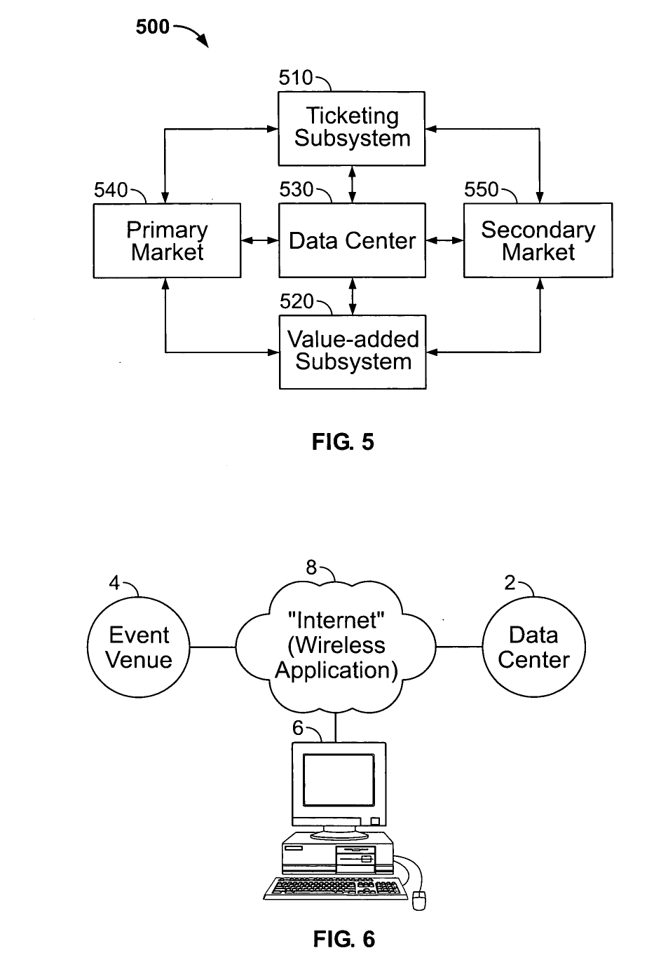

FIG. 5 illustrates an example of a fan lifecycle management (FLM) system 500 used in accordance with an embodiment of the present invention. The FLM system 500 includes a ticketing subsystem 510, a value-added subsystem 520, and a data center 530. The system 500 may also include a primary market 540 and a secondary market 550. The ticketing subsystem 510 facilitates primary and secondary market ticket sales and resales and extracts information related to ticket transactions from a buyer and/or seller, for example. The value-added subsystem 520 provides value-added services and/or products to customers before and/or after an event based on information gathered in the primary and/or secondary markets.

The data center 530 stores electronic data related to tickets, ticket sellers, and/or ticket buyers, for example. The data center 530 may be a centralized or distributed database, data warehouse, data archive, data store, data memory, and/or other such data module, for example. The data may be used to facilitate electronic ticket sales, secondary market electronic ticket resales, sale of value-added products or services provided prior to an event, and/or sale of value-added products or services provided after an event, for example. The data center 530 may extract electronic data from primary market and secondary market ticket transactions and other related transactions, for example.

Data stored in the data center 530 may be used to provide products and/or services to ticket buyers, ticket sellers, and/or potential ticket buyers/sellers. Data in the data center 530 may be used by a venue and/or organization to tailor products and/or services for a particular event, venue, customer, region, and/or other demographic, for example. Data may be used to set price, time limits, quantity limits, etc. Data may be analyzed manually and/or automatically to provide trends, reports, projections, statistics, and/or other data analysis, for example. In an embodiment, the data center 530 may include a processing component and/or be connected to another system for retrieval and/or processing of data.

In an embodiment, the components of the system 500 may form an exchange 560 providing primary and secondary market ticket sales, resales, transfers, and other trading, as well as value-added products and services. The components of the system 500 may be implemented in software, firmware, and/or hardware and may communication in a variety of ways, such as by network, wire, wireless, etc.

In operation, for example, primary market tickets may be issued electronically by a venue/organization. For example, season tickets may be issued electronically by the ticketing subsystem 510 to season ticket holders on the primary market 540. The ticket holder accesses a secure ticket area and views his/her ticket inventory. For example, a season ticket holder accesses a secure website for the organization and views his/her ticket inventory for the season. To enter an event, the ticket owner simply scans his/her driver's license, credit card, or other identification at the gate. The ticket owner may also generate a seat assignment stub or verification at the event. In an embodiment, a portable or stationary scanner, such as a credit card or identification scanner, may be used to verify and grant access to a venue. In an embodiment, a receipt printer may be provided to generate printed verification of access after access has been granted. In an embodiment, the scanner and printer may be integrated into a kiosk and/or handheld device, for example.

Alternatively, the ticket holder may post one or more tickets for sale on the secondary market 550. For example, the season ticket holder may post a ticket or set of tickets for sale on a secondary market website tailored to the organization/venue. The website may be a separate website dedicated to the organization/venue or may be a customized interface accessing a centralized secondary market 550 for a variety of ticket resales, for example. When tickets sell on the secondary market 550, a buyer provides credit card and/or account information to purchase the ticket(s) and then uses that information to enter the event. For example, data (e.g., drivers license or credit card data) used by the buyer at the event is compared against data in the data center 530 to allow access to the event. In an embodiment, a transfer may be accomplished by invalidating a ticket record for the seller and creating a new record for the ticket buyer. Alternatively, a ticket record may be modified to reflect a new ticket holder. When a transaction occurs, the seller may be notified and credited, the buyer is debited, and a premium may be credited to the organization/venue, for example. Access may be granted by verification of ticket holder authentication data against a ticket record, for example. Once access has been gained, a flag or other indicator may indicate that the ticket record has been used, for example.

Certain embodiments provide an interface for access to a ticket exchange. The interface may allow one or more users to view tickets, buy tickets, trade tickets, sell tickets, transfer tickets, and/or purchase related products/services, for example. In certain embodiments, users may become members of the ticket exchange. A user login and password or other identification method may be used to access the interface and ticket exchange. Alternatively, all or part of the ticket exchange functionality may be available without membership or registration. In an embodiment, transactions via the interface and exchange may be free or may be associated with a per transaction fee and/or membership fee, for example. In certain embodiments, transactions via the interface and ticket exchange may be funded by a pre-funded account, a credit card, a bank account, an online payment service such as PayPal®, etc.

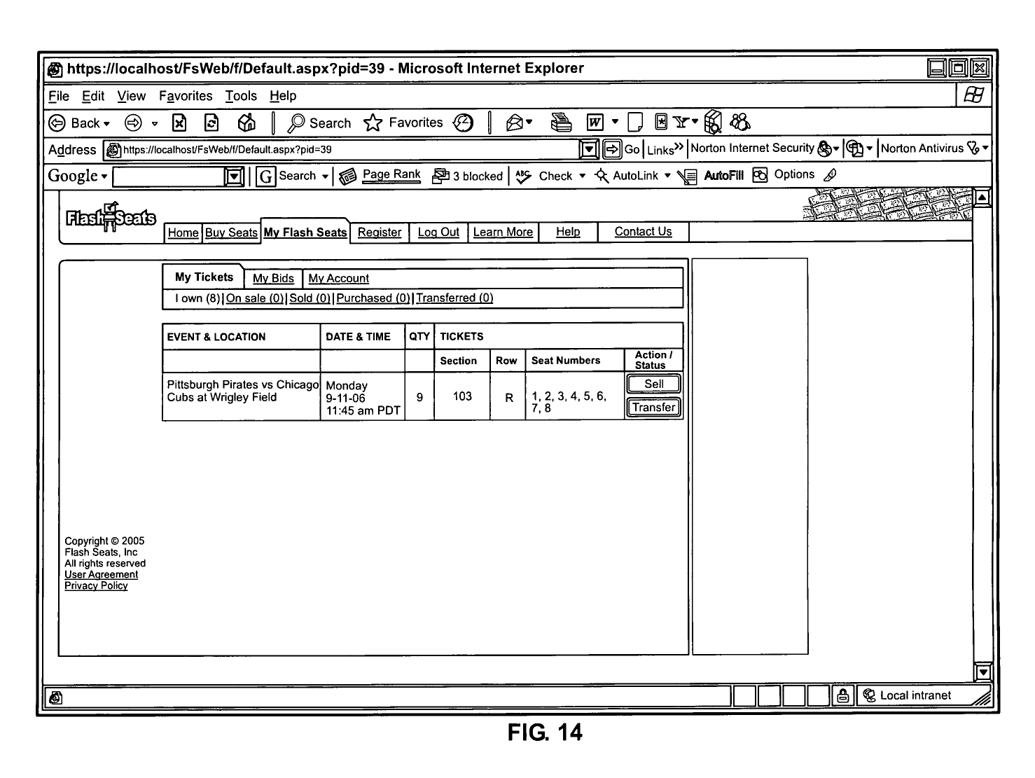

FIG. 14 illustrates an example of a user inventory interface used in accordance with an embodiment of the present invention. As a user accesses the interface, the FLM interface may recognize a specific user or user group and automatically bring up that user's particular inventory. The inventory may include tickets, but also may include products and/or services, such as pre-paid parking, merchandise and concessions, travel related services, post-event orders, etc. Inventory may include, but not be limited to, the event and location, date and time, quantity of tickets, section, row and seat number, etc.

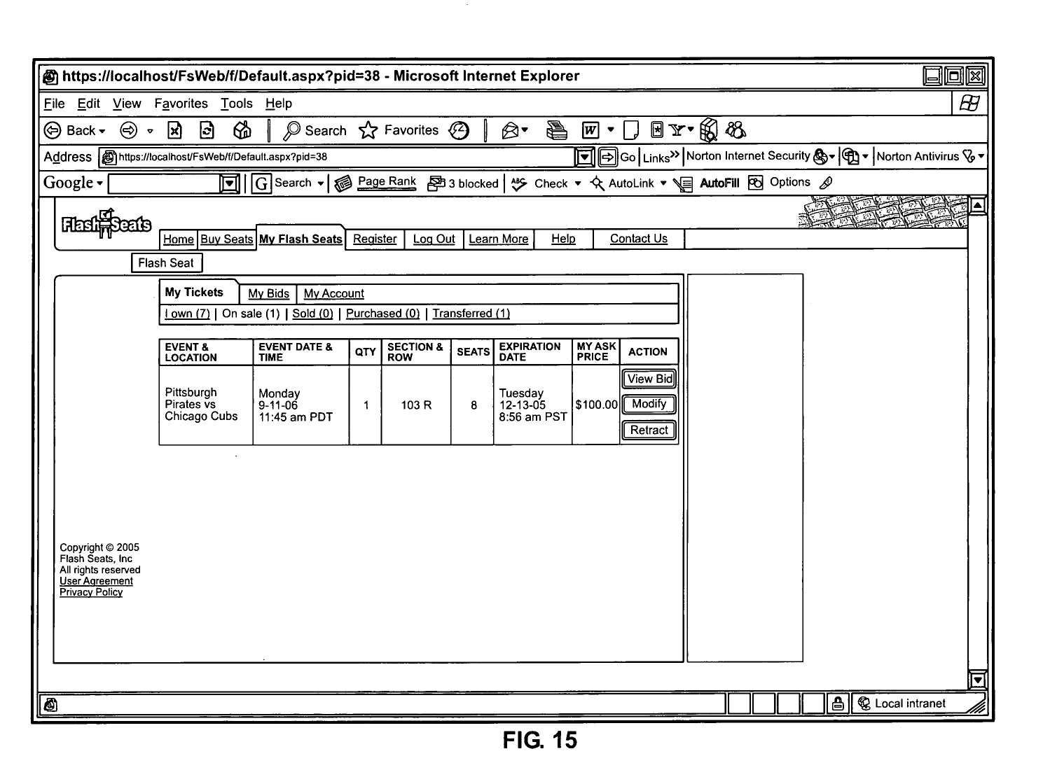

As depicted in FIG. 15, certain embodiments may also show the tickets that a particular user currently has for sale or are “on sale.” Information may include, but not be limited to, event and location, date and time, quantity, section, row, seat number, the expiration date of the listing, the asking price, actions buttons, etc., that allow the user to view current bids, modify a listing, and/or retract a listing, for example.

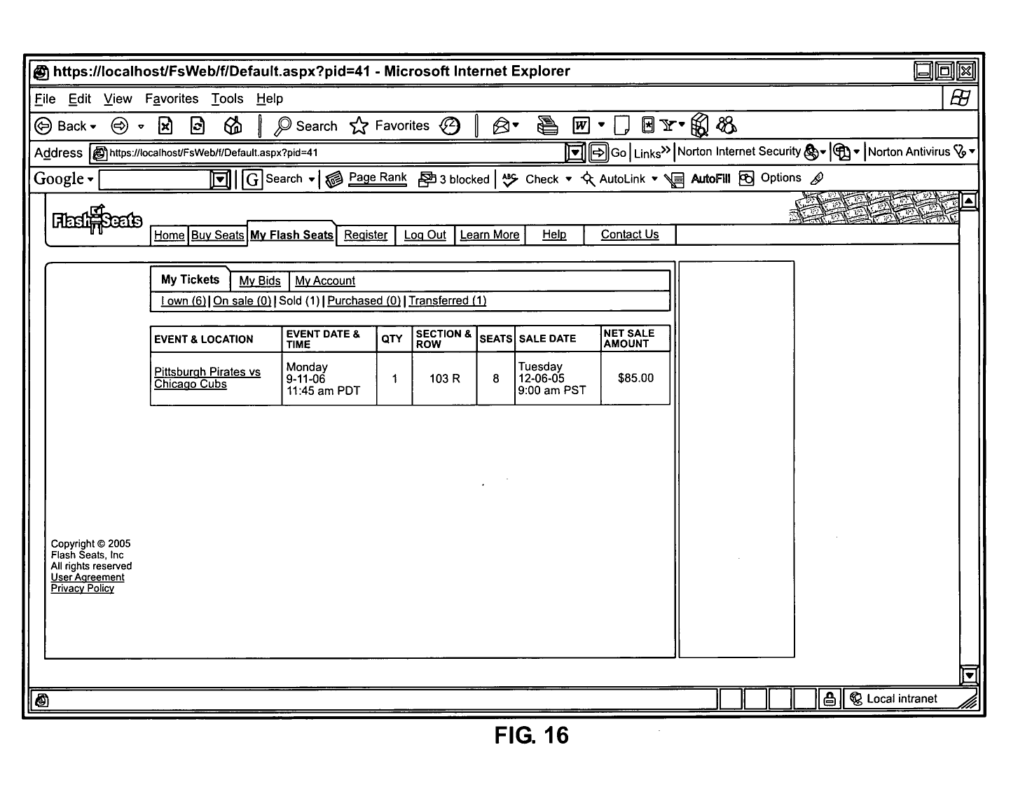

FIG. 16 depicts an example of an interface view allowing a user to view an inventory of tickets or other products and services that the user has sold. This view may provide a historical view of what was sold, at what price and when, a digital receipt, etc. Users may also get more detail on a specific item, for example.

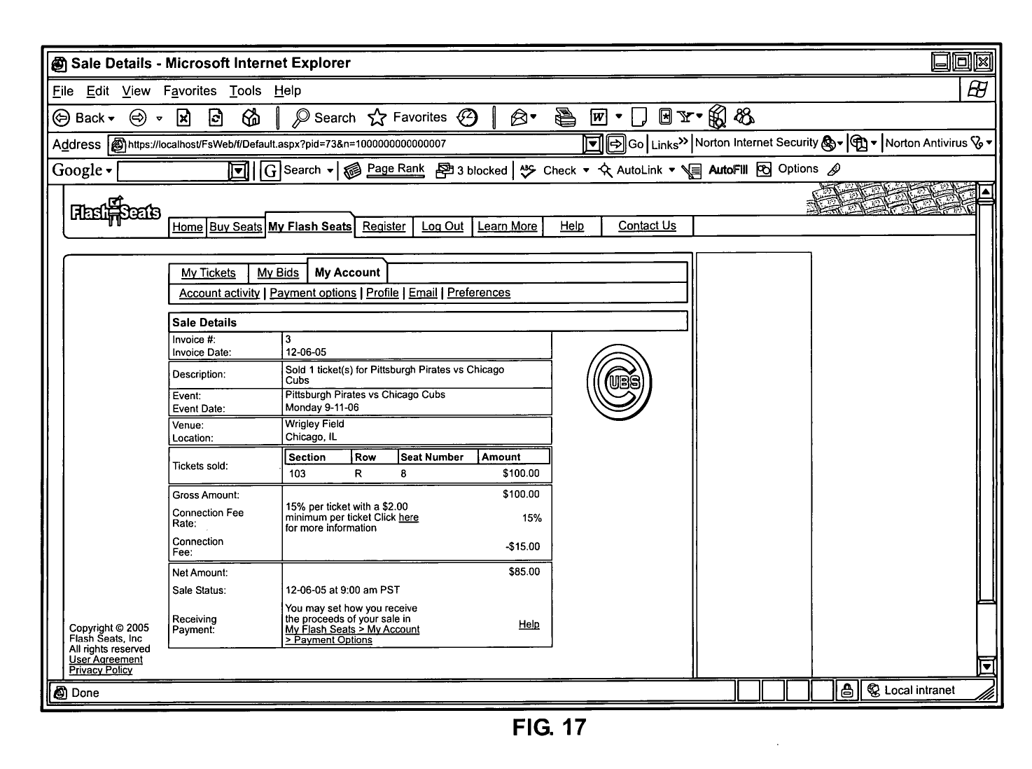

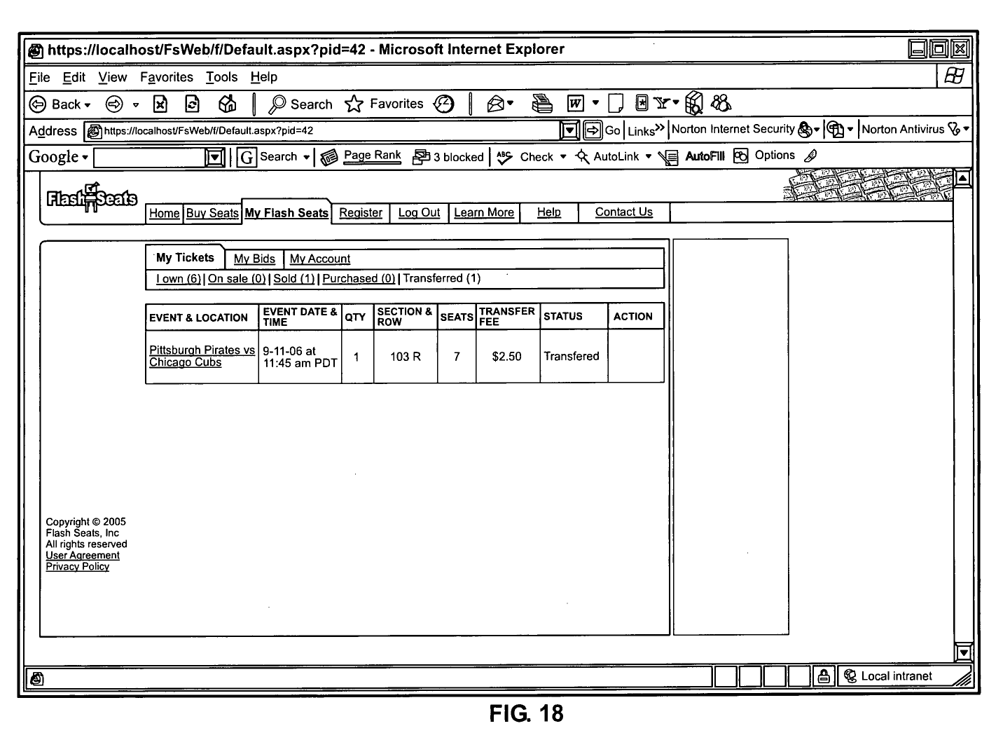

The view shown in FIG. 17 allows users to see detailed information on what tickets were sold, where the tickets were located, and fee(s) associated with that sale, for example. FIG. 18 depicts an exemplary view allowing users to see what tickets were transferred and fee(s) associated with that transfer, for example. In an embodiment, the detailed views of FIGS. 17 and 18 may be accessible from the inventory view of FIG. 16, for example. Data from the views of FIGS. 16, 17 and 18, for example, may provide a user, organization, venue, and/or ticket exchange with information regarding ticket usage, ticket prices, sales and pricing of other products and/or services, etc.

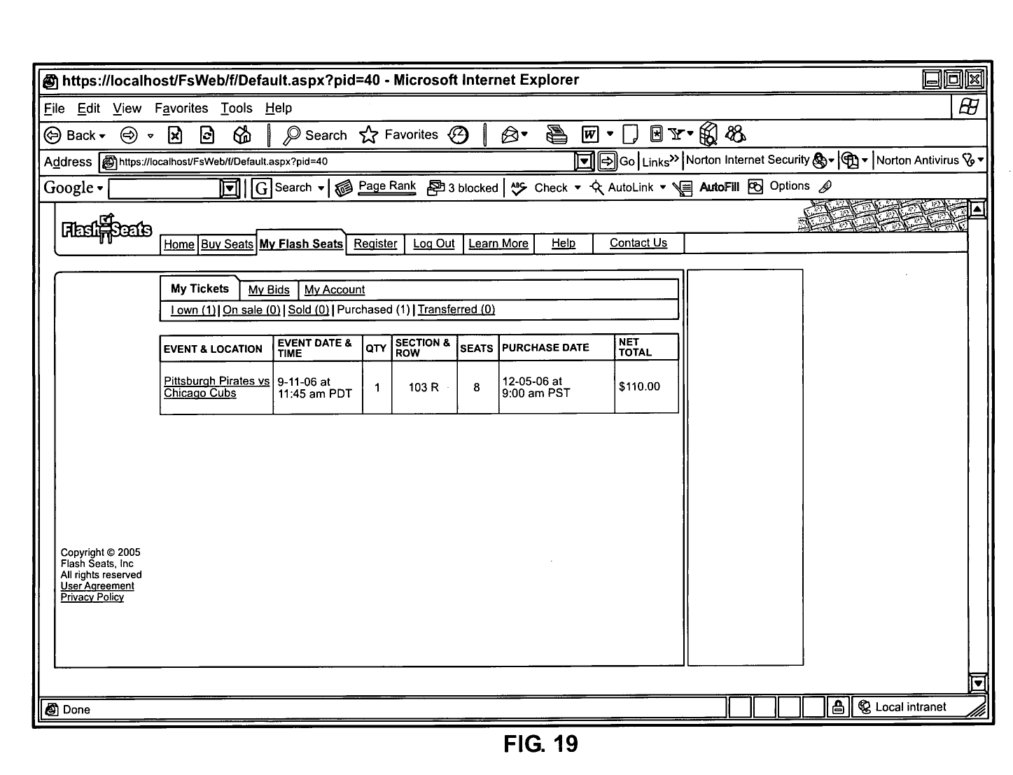

Buyers may also have informational views via the FLM interface. For example, the view of FIG. 19 shows detail regarding a purchased ticket. Similar to seller information, buyer information may provide a user, organization, venue, and/or ticket exchange with information regarding ticket usage, ticket prices, sales and pricing of other products and/or services, etc.

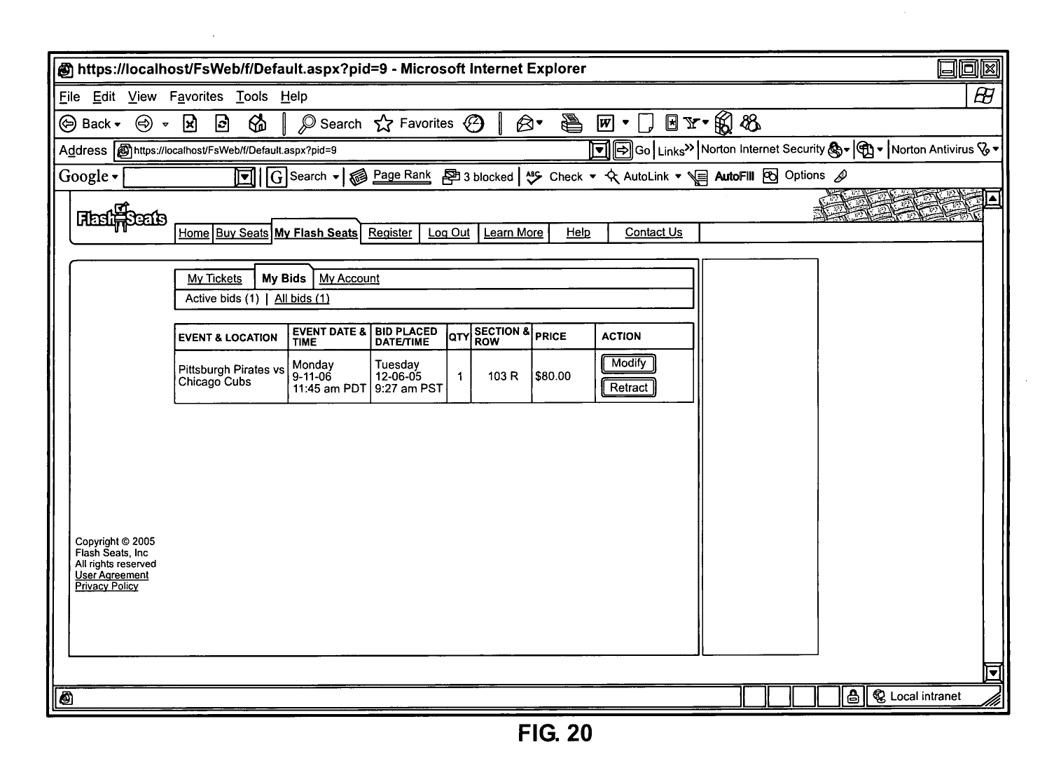

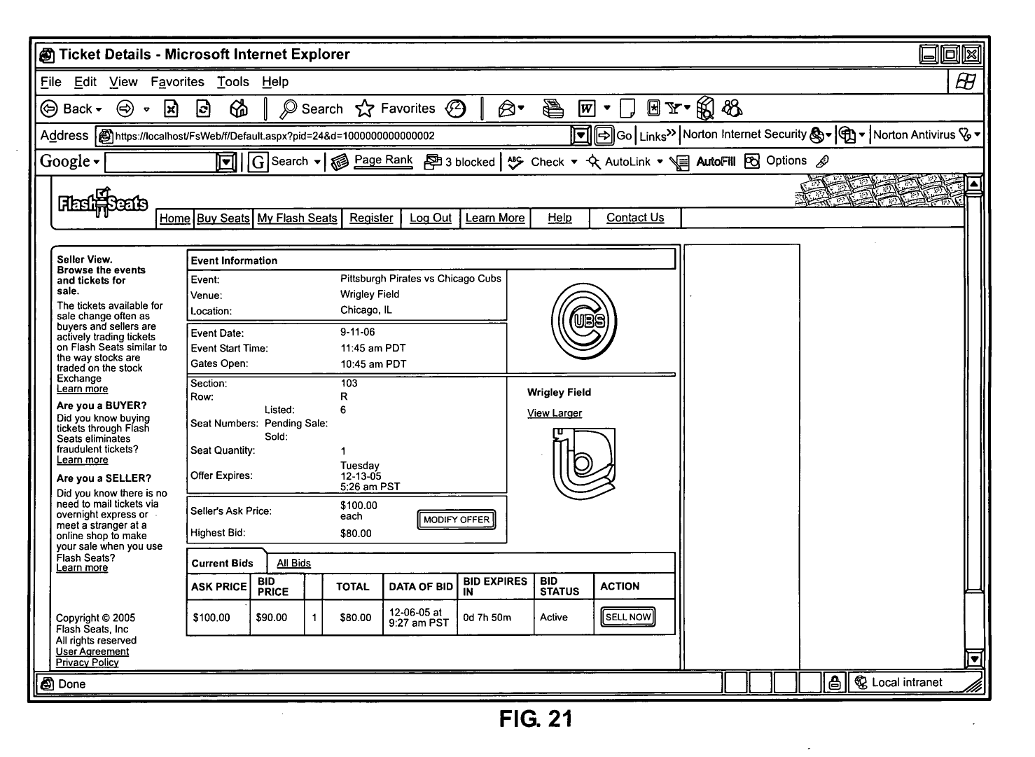

FIG. 20 shows information regarding the tickets that are actively listed in the ticket exchange, for example. The interface may allow a user to view and/or interact with tickets and/or other items offered on the exchange, for example. In certain embodiments, bids on tickets may be retracted and/or modified by the user at any time or within a certain time interval, for example.

A view depicted in FIG. 21 shows an interface allowing a seller to modify offered tickets, view any bids that are currently on the offered tickets, and/or use the “Sell Now” button. By using the “sell now” button, a seller may configure the FLM system to automatically sell the ticket, product or service to the highest bidder. This feature allows the seller to quickly and easily sell a ticket to a new person.

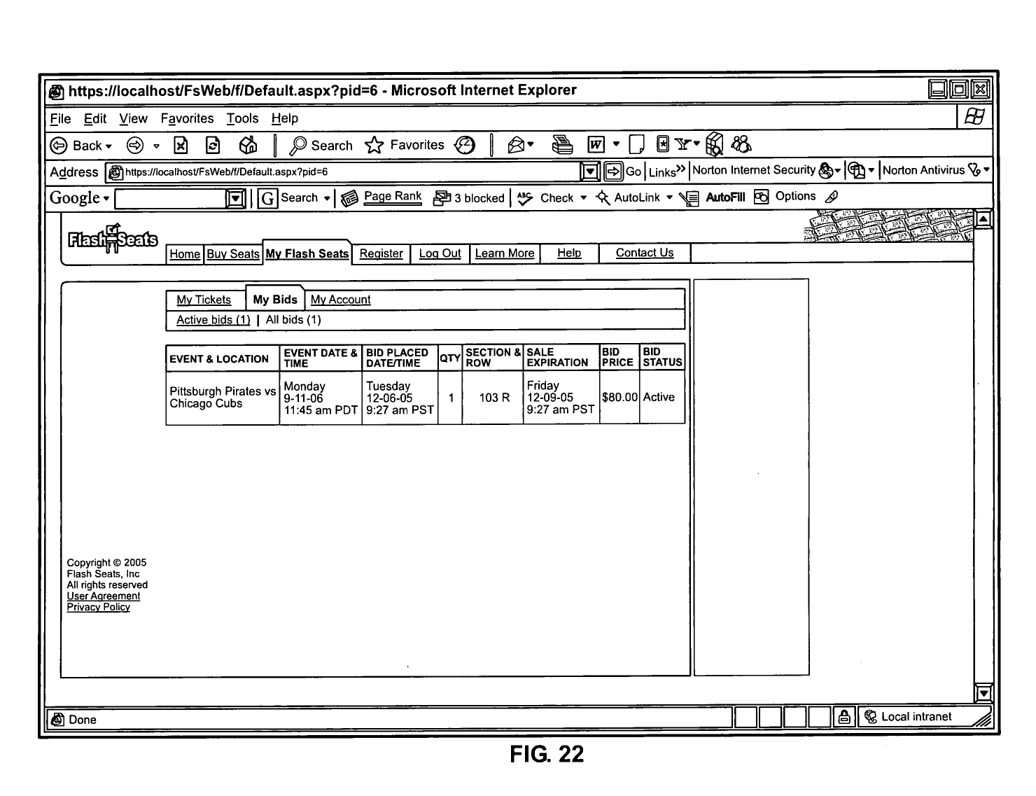

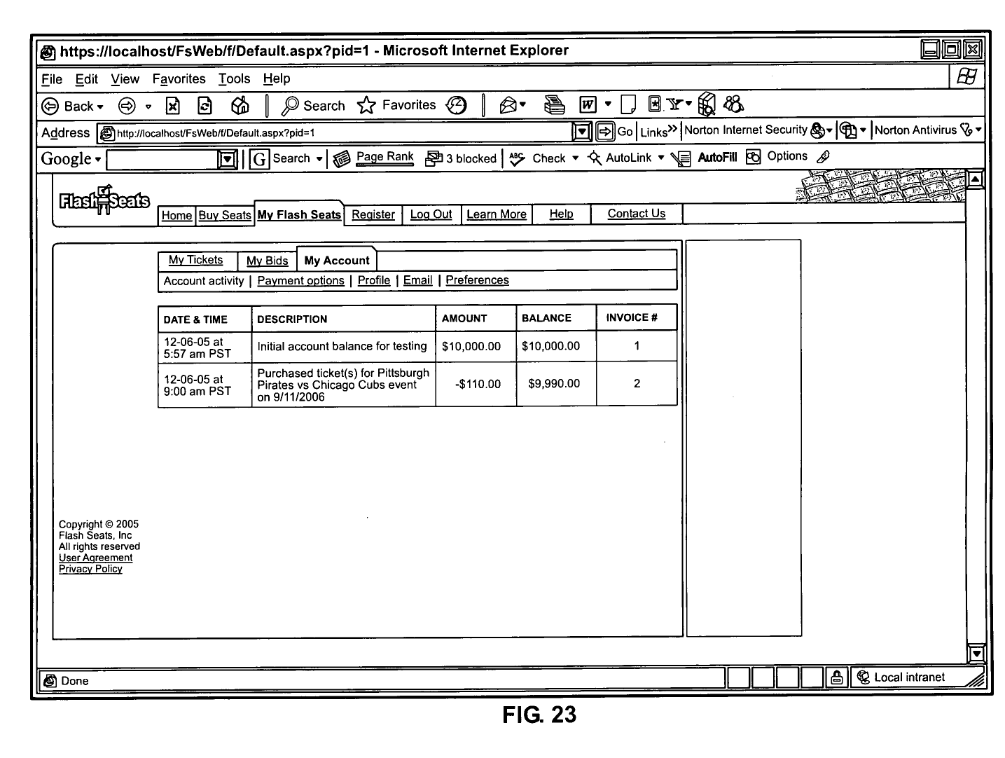

As shown in FIG. 22, a user may also access a view that shows all of his or her bids, whether the bids are active or not. Additionally, using the interface, as illustrated in FIG. 23, a user and/or administrator may view account activity on a particular account, for example.

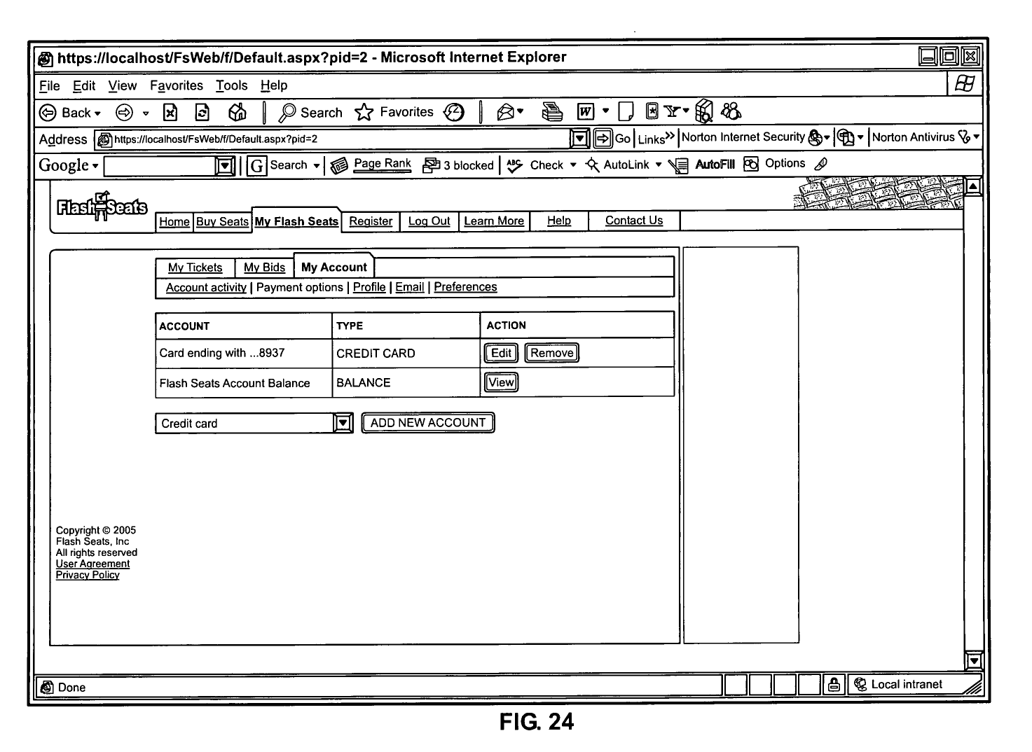

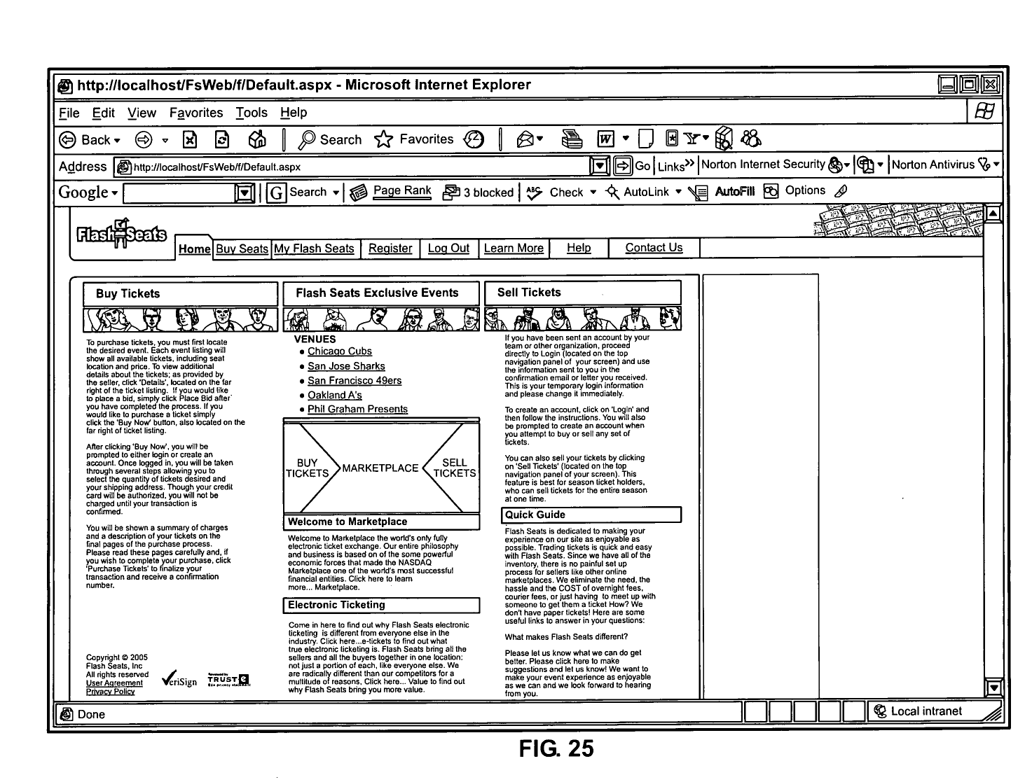

Furthermore, as shown in FIG. 24, an interface may be used to view payment options for a particular user and/or venue. In an embodiment, a user may change payment options to reflect changes in credit card, drivers license, etc., or if they simply wish to change from one form of identification to another. In an embodiment, a venue and/or organization may change payment options to reflect forms of payment currently accepted by the venue, organization, and or ticket exchange. In certain embodiments, a user may be presented with an introductory interface screen, such as the example of FIG. 25, that lists participating and/or available organizations, such as teams theaters and/or musical groups, venues, and/or tickets. A buyer may click on or otherwise select them. In certain embodiments, geographic areas, venues and/or types of entertainment, may include a drop down menu, for example, to narrow down choices. Additionally, in certain embodiments, a word search may reduce results for a buyer.

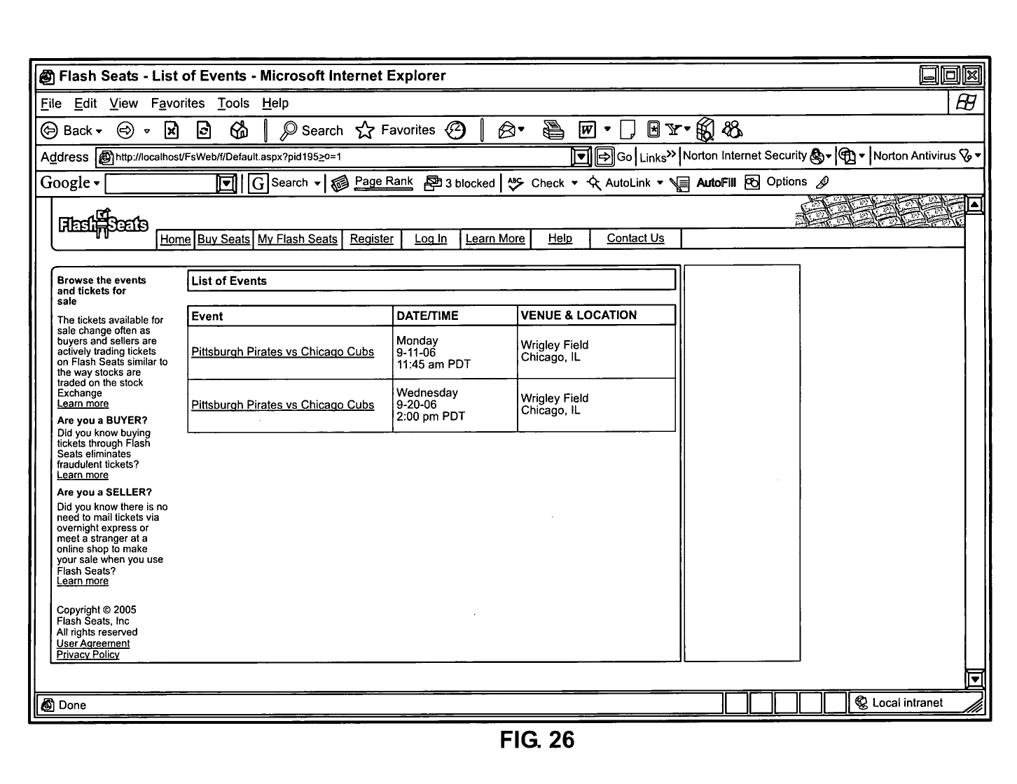

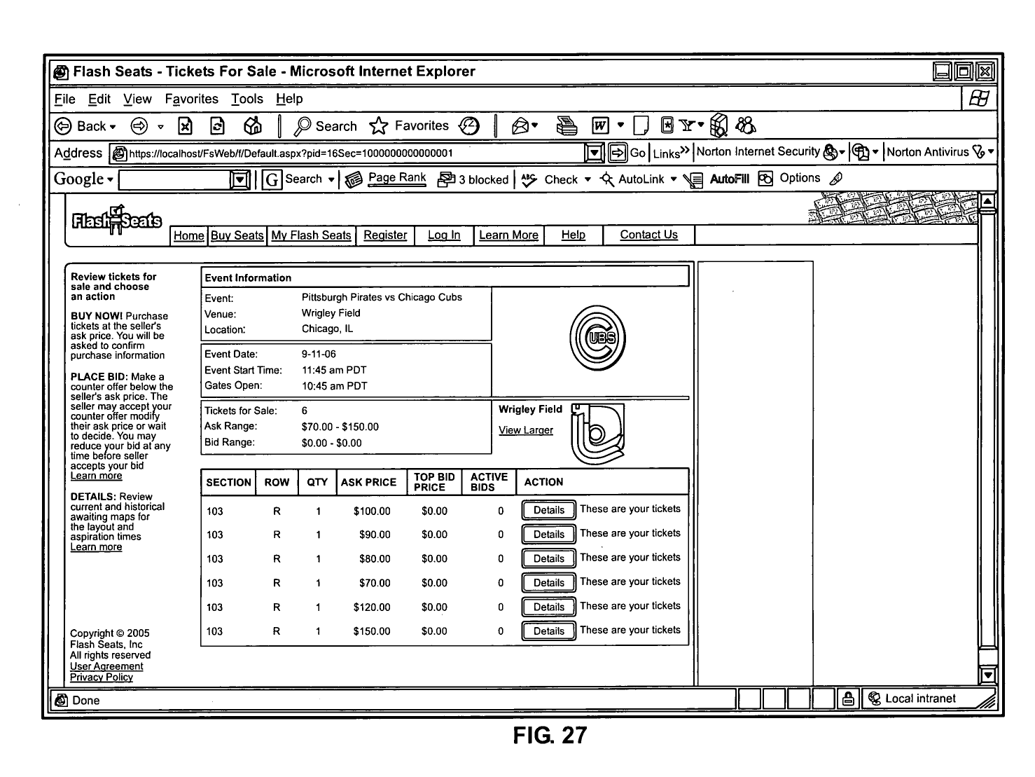

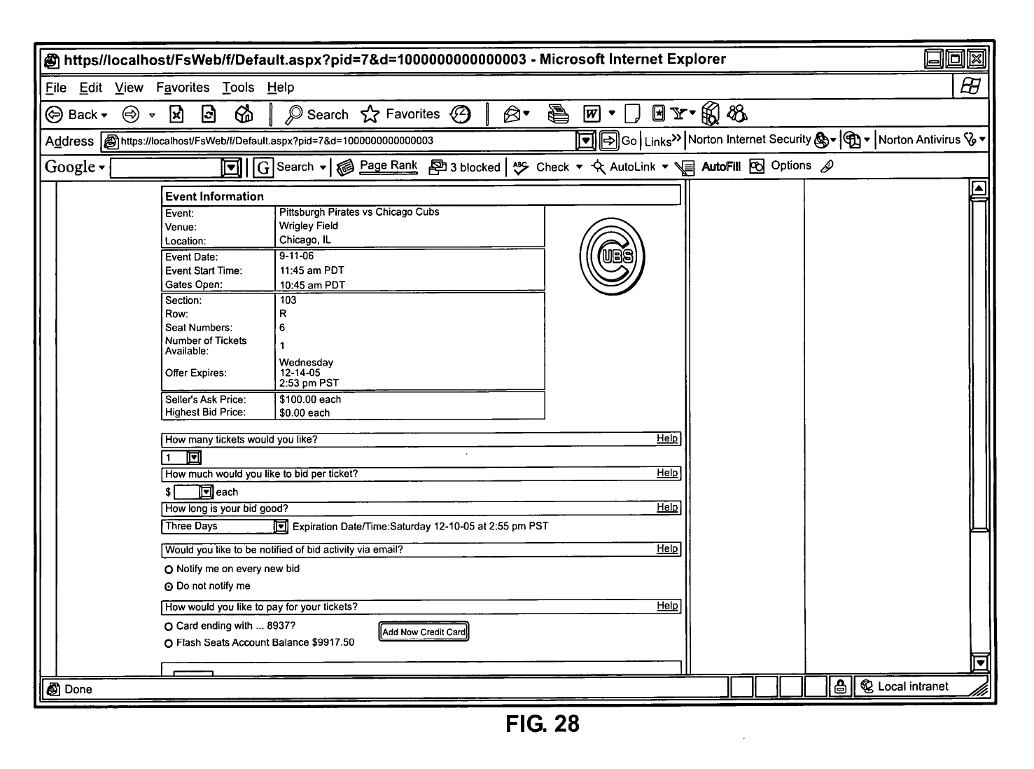

After a buyer selects a team, for example, events available for that team may be displayed. As shown in FIG. 26, the buyer may view events for the team and select an event to find tickets. Then, as illustrated for example in FIG. 27, a buyer may view the tickets for sale for that event. FIG. 28 illustrates an exemplary interface allowing a buyer to make a bid for the ticket(s).

Certain embodiments allow a venue or organization to manage data related to ticket sales and other products/services. Certain embodiments provide local and/or hosted storage and management of customer and/or inventory data, for example. For example, an organization may gather data regarding customer inquiries, customer purchases, customer offerings, etc. Data may be tracked from customer activity prior to an event to customer activity during the event and customer activity after the event. Data may be aggregated over multiple events and/or periods of time for a customer and/or group of customers, for example. Organizations/venues may use data to better control and/or tailor their product(s)/service(s) and to help increase revenue, for example. Additionally, data may be used to increase customer satisfaction. Buyer data obtained upon a ticket purchase, for example, may be used to allow a venue to offer concessions, parking, further tickets, etc., to that customer. Seller data may be used to allow a venue to offer alternate opportunities and/or benefits, for example. Customers may be notified of upcoming events, memorabilia, and/or other opportunities, for example, based on data collected in primary and/or secondary market activity. Furthermore, data may be analyzed to provide trends and other feedback to an organization/venue, for example.

Certain embodiments may operate in conjunction with a plurality of electronic ticketing systems, access systems, and other venue/ticketing systems. FIG. 6 illustrates an electronic ticketing system used in accordance with an embodiment of the present invention. The system includes a data center 2, a plurality of venues 4, and a plurality of terminals 6. The data center 2 is in communication with each venue 4 and each terminal 6 through the Internet or any wireless application 8. The terminals 6 may be any device through which a user may access a website, for example: a personal computer, a personal digital assistant, an Internet-through-television device, or any type of many available wireless devices available in the market.

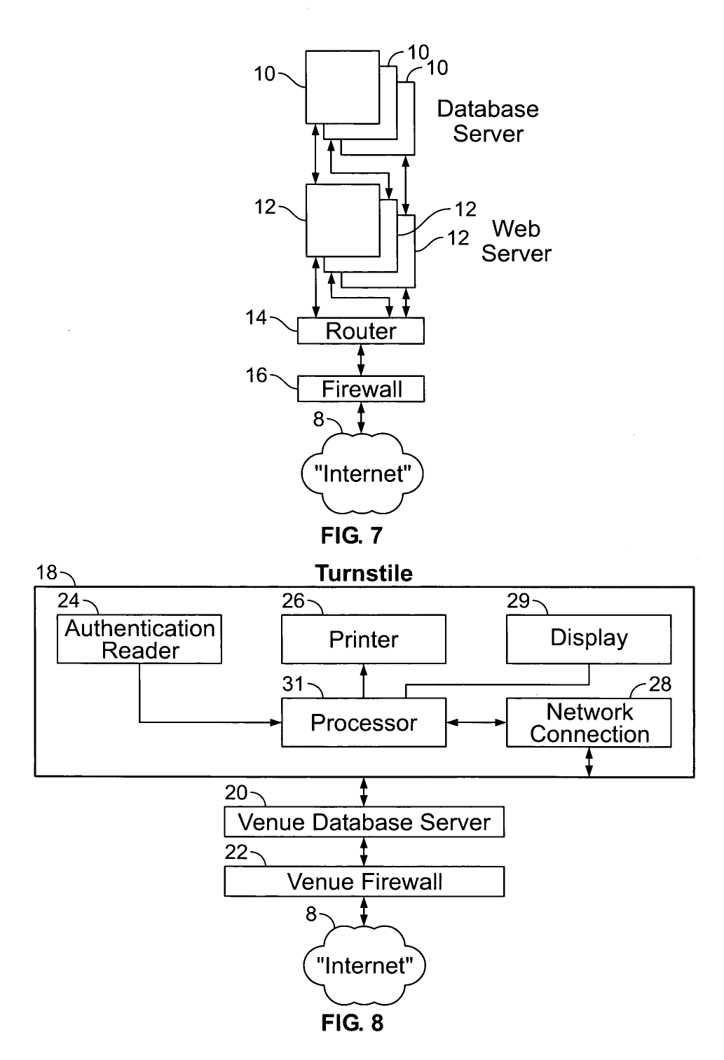

Referring to FIG. 7, the data center 2 preferably comprises database servers 10, web servers 12, a load balancing router 14 and a firewall 16 connected to the Internet 8. The firewall 15 receives messages from the Internet 8 and forwards the messages to the load balancing router 14 and likewise receives messages from the load balancing router 14 and forwards them to the Internet 8. The firewall 16 preferably performs a number of filtering functions and network address translation in order to safeguard the data center 2 from unauthorized access. The firewall 16 also preferably encrypts the messages using known public key/private key encryption methods. The load balancing router 14 forwards messages received from the firewall 16 and forwards the messages to one of the plurality of web servers 12. The load balancing router 14 also forwards messages received from the web servers 12 to the firewall 16. In this manner, the load balancing router 14 distributes tasks to be performed to one of the plurality of web servers 12 in order to distribute processing demands. The web servers 12 access the database servers 10 to retrieve and store information in response to received messages from the terminals 6 and transmits reply messages to the terminals 6. The database servers 10 store data tables which contain information about various venues, events, ticket resources, user roles, ticket status, ticket holders and ticket bidders, as will be explained in greater detail below.

Referring to FIG. 8, within each venue 4 are a plurality of turnstiles or any entry devices 18, a venue database server 20 and venue firewall 22 connected to the Internet 8 for communicating to the data center 2. The turnstile or any entry device 18 of the venue 4 comprises an authentication reader 24, a printer 26, a network connection 28, a display 29 and a processor 31. The authentication reader 24 is preferably a magnetic card reader. However, other types of cards may be used, such as cards incorporating single- or multi-dimensional bar codes or wireless methods of communication, without departing from the scope of the present invention. The network connection 28 allows the turnstile or any entry device 18 to communicate with the venue database server 20 in order to provide information about the card being scanned and to receive information about whether to grant or deny entry to the venue 4. The turnstile or any entry device 18 preferably is a compact unit which runs from embedded software within the turnstile or any entry device or from a server located on site or remotely 18. While the turnstile or any entry device 18 is described as being connected with the venue database server 20 with a wire, one of ordinary skill in the art can easily recognize that communication between the turnstile or any entry device and database server can be implemented by radio frequency, optical communication or any other method of wireless communication without departing from the scope of the present invention.

In certain embodiments, the turnstile or other entry device 18 may be a hardwired device. In certain embodiments, the turnstile or other entry device may be a portable wireless scanner. For example, the entry device 18 may be a scanner or card reader attached to a printer or printing device that is connected to a wireless infrastructure at a venue. The wireless infrastructure may be connected to the server 20 at the venue and may have access points that connect wirelessly to multiple different entry devices 18. These devices 18 read authentication data and transmit the data wirelessly to an access point, which then communicates back to the server 20. The venue database server 20 maintains a record of the tickets have been sold, the ticketholders have passed through the turnstile or any entry device 18 and which ticketholders have not yet arrived. The database server is preferably a computer running UNIX, Windows NT, Java or Sparc and having an Oracle, Informix, Sysbase or SQL Server database. In certain embodiments, a receipt or ticket verification may be printed after access to the event has been granted. In certain embodiments, a receipt or ticket verification may be printed when access to the event is granted.

In order to implement the present invention, an end user can access the data center 2 by using a standard web browser on the terminal 6. However, non-standard, custom software can also be implemented or web browser software on a wireless device, such as a personal digital assistant. Terminals 6 can log into the data center 2 to view events which will take place in the future, purchase tickets in the primary market from the event sponsor, offer tickets for sale in the secondary market, purchase tickets in the secondary market and purchase merchandise or services related to the event. When the user has entered the appropriate address of a desired data center 2, e.g., an on-line ticketing web page, the user can view a calendar of events to search for a desired event or choose a venue to see what events will be appearing at the venue in the future. After selecting an event which the user desires to attend, the user may purchase tickets for the event from the event sponsor. Additional products and services can also be offered at the time of ticket sales. After the ticket is sold and before the time of the event, the ticket can be transferred by the ticket owner to subsequent ticket buyer.

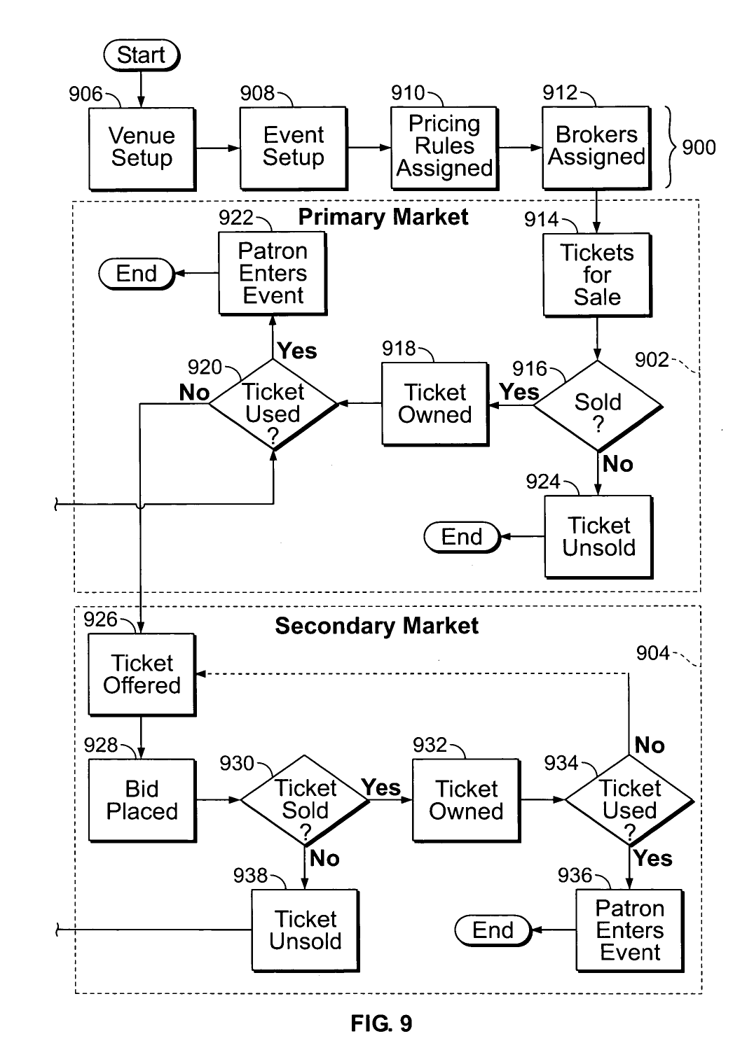

Referring to FIG. 9, the ticket has a determined life cycle which is tracked by the system of the present invention. The steps of the life cycle are: ticket setup 900, primary market 902 and secondary market 904. In the ticket setup step the ticket is assigned a venue 906, an event 908 and ticket pricing rules 910 are associated with the ticket. Additionally, brokers may be assigned to the ticket 912 in order to transfer the ticket in a multi-broker environment. In the primary market step 914 the ticket is offered for sale. If the ticket is sold or otherwise transferred 916, the ticket becomes an “owned ticket” 918. If the ticket is used 920 by the person it is sold to, the patron is allowed to enter the event 922 and the tickets life cycle ends in the primary market. If the ticket is not sold before the time of the event 924, the ticket's life cycle ends having been unsold in the primary market.

If the ticket is not used in the primary market, it may be traded in the secondary market 926. There is no limit how many times the ticket may be traded in the secondary market before the time of event. Many options are available for sales, trades, transfers and/or other exchanges of tickets in the primary and secondary market. Sales of tickets can be made using traditional methods, such as by offering a ticket for a fixed price or a scaled price (i.e. student and senior citizen discounts). Tickets can also be offered using a non-traditional format such as in an auction-type format, a reverse auction-type format or in an exchange-type format. In an auction-type format, event sponsors can place groups of tickets on sale and sell them to highest bidder after a fixed period of time. Many different options are available for the auction-type format, such as allowing users to place bids for groups of tickets. If the user's bid cannot be satisfied at the present price for all seats, the bid fails. Alternatively users can place a bid for which, if the bid cannot be fulfilled for the quantity of seats of the bid, the number of seats in the bid is reduced. Using the auction type format, the event sponsor may achieve a higher price per ticket than with a fixed price sale. A reverse auction type format is similar to an auction-type format with the caveat that the event sponsor “bids” to sell the ticket rather than users bidding for the right to buy the ticket.

In an exchange type format, tickets are sold in the primary market by event sponsors who advertise an ask price for a particular ticket. At the same time, users advertise a bid price in order to purchase a particular ticket in a particular section of the venue. Both the ask price and the bid price remain valid for a particular period of time. If the ask price advertised by event sponsors is higher than the bid price advertised by any particular user, no ticket is sold. However, when a bid price equals an ask price, a sale of a ticket is made. Additionally, bids may specify quantities of contiguous seats as well as a bid price. In a like manner, event sponsors can specify quantities of contiguous seats along with the ask price. An event sponsor may wish to specify a minimum number of contiguous tickets to prevent large blocks of seats from being broken up or to force the sale of an exact number of number of seats in order to prevent a single seat in a block from being unsold (i.e. to prevent selling two seats of a block of three unsold seats). An event sponsor may wish to specify a maximum number of seats in order to prevent a large quantity of seats being purchased by one person or entity. When a user's bid price equals a sponsor's ask price and a quantity of seats for an event is within the sponsor's minimum and maximum quantity of seats, a sale is made. Therefore, the main difference between an auction type format or a reverse auction-type format is that sales are made instantaneously when a bid price equals an ask price for a ticket.

Alternatively, for different classes of seating at the venue, a combination of sales formats can be implemented. For example, for a sporting event, seats which have a premium, such as box seats and luxury boxes, an event sponsor can implement a non-traditional format which seeks to secure the highest market price and implement a traditional format of ticket sales for the remaining seats. Also, tickets may be sold in the primary market by a particular method and sold in the secondary market by another method. Tickets may also be sold in the primary market by one method and sold in the secondary market by one of multiple available methods.

During the step of offering the ticket 926, a price is associated with the ticket. Depending on the format the price has a different significance. For example, the price may be a first bid price or, in an exchange type format, the price may be an ask price. Next bids are placed on the ticket 928 until the ticket is sold 930. If the ticket is sold the ticket is now owned by the new buyer 932 who may use the ticket and enter the event 936 or offer the ticket for resale 926. If the ticket remains unsold 938, the ticket may be used in the primary market 920. Additionally, unsolicited bids can be placed for a ticket. Anyone seeking to buy a ticket can specify the price at which he or she is willing to buy and wait to see if a ticket owner is willing to sell at that price.

Each time a ticket is transferred new ownership information is associated with the ticket. Ownership information could be credit card numbers used to purchase the ticket, a cell phone number, a digital encryption on a personal digital assistant, or a single- or multi-dimensional bar code. The two dimensional bar code can be printed by the user in order to provide a physical indication of ticket ownership. In order to provide an incentive for event sponsors to grant permission to sell the tickets in the secondary market, the present system provides that for sales in the secondary market the event sponsor will receive a royalty. Royalties can be a flat fee or a fee based on the sales price of the ticket in the secondary market.

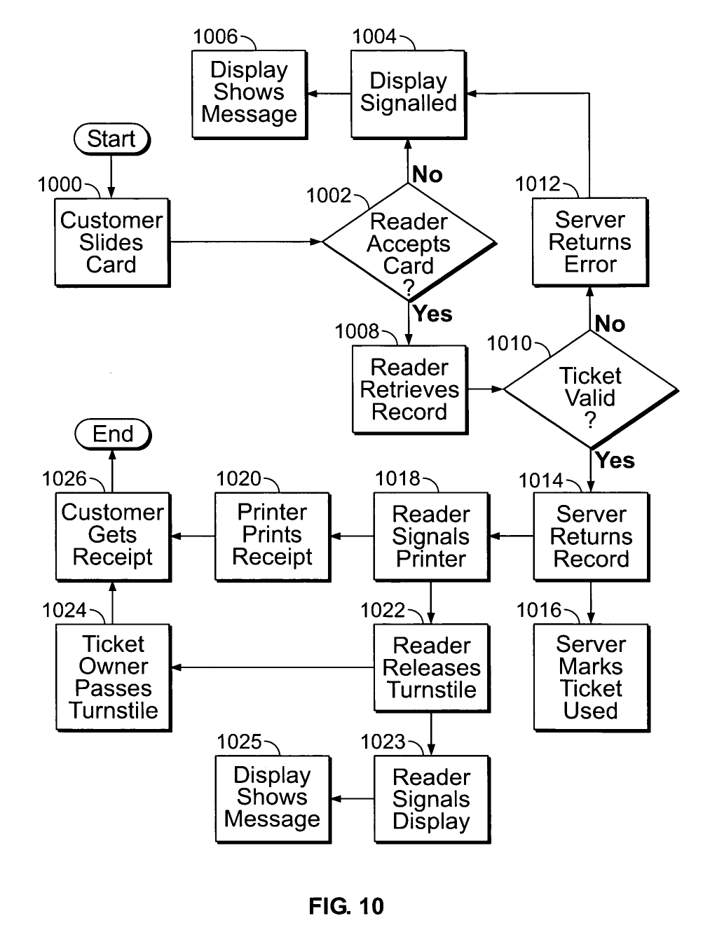

Referring to FIG. 10, upon arriving at the venue to attend an event, the ticket owner authenticates himself to the event sponsor in order to gain entry to the venue. Authentication can occur in a variety of ways including infra-red wireless scanning. In one example, the ticket owner slides the credit card 1000 associated with the ticket through the authentication reader 24 on a turnstile or any entry device 18. Alternative methods for authentication could be implemented such as bar coded authentication tickets, as described above. If the authentication reader 24 unsuccessfully scans the authentication 1002, the reader signals the display 1004 to indicate that the authentication was not successfully scanned 1006. If the authentication is successfully scanned the reader queries the venue database server 20 to determine whether the ticket is valid 1010. If the ticket is not valid, the venue database server 20 returns an error 1012 and the display is signaled 1004 and message displayed 1006. If the ticket is valid, the venue database server 20 returns a message indicating the ticket is valid 1014.

Next, the venue database server 20 marks the ticket as used 1016 within the database and signals the printer 26 to print a receipt 1016 and the printer responds by printing a receipt 1018. The authentication reader 24 also releases the turnstile or any entry device 18 (step 1022) and signals the display 1023 which displays a message 1025. Next, the ticket owner passes through the turnstile or any entry device 1024 to allow the ticket owner to enter the venue 4.

In order to implement the present system, user roles are implemented, such as: venue management, event management, event marketing, ticket owner, ticket buyer and administration. The roles may interact with the system in order to fulfill necessary tasks by either using terminals 6 connected via the Internet 8 or directly to the data center 2 or venue 4. A user fulfilling a venue management role can enter information regarding the venue such as seating charts, directions to the venue and entrance gate information. A user fulfilling an event management role can enter information about an event to take place at the venue, such as the name, time, date, seating configuration of the venue, ticket pricing for the event and merchandise to be offered to ticket purchasers. A user fulfilling an event marketing role can enter information pertaining to products and services that are offered to users upon offer or completion of a ticket sale. A user fulfilling the role of a ticket owner can enter information regarding the price (first auction bid or ask price, as appropriate) and identity of the ticket or tickets. A user fulfilling the role of ticket buyer can enter information regarding the quantity and price (an “auction bid” price or an “exchange bid,” as appropriate). A user fulfilling the role of administrator preferably has the rights of all roles and any additional task necessary for maintenance of the system.

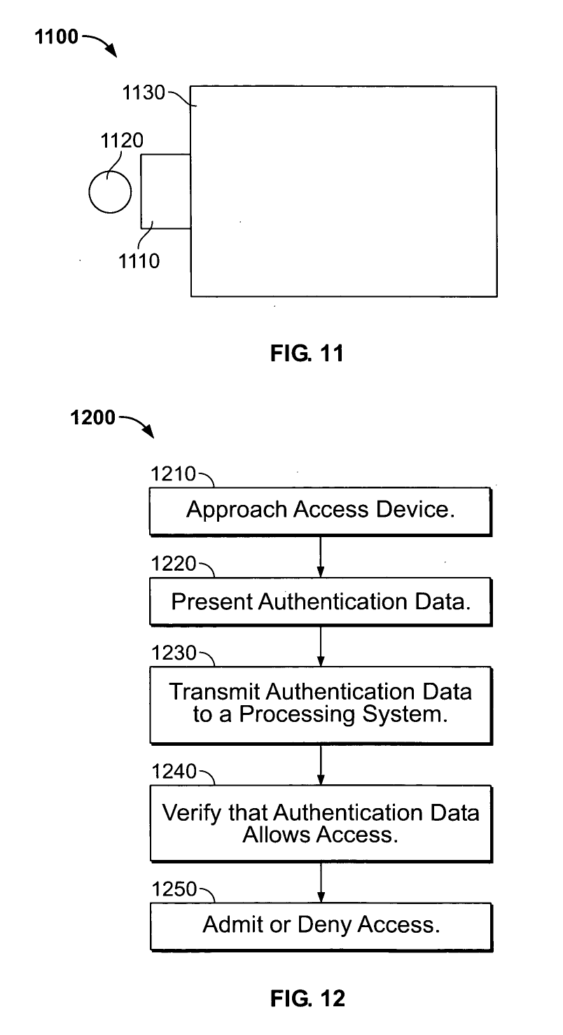

FIG. 11 shows an electronic ticketing and access system 1100 used in accordance with an embodiment of the present invention. The electronic ticketing and access system 1100 includes an access device 1110. The access device allows a patron 1120 to access a venue 1130. The access device 1110 may include a turnstile or any entry device, such as the turnstile 18, a card reader, any wireless access device, an access gate, or other access device. The access device 1110 may be a handheld access device, such as a handheld scanner, handheld barcode reader, or other handheld device. The access device 1110 may be a wired and/or wireless access device. Alternatively, the access device 1110 may communicate via infrared or other data transmission medium. The access device 1110 may be a standalone unit or may be one of a plurality of access devices 1110. The plurality of access devices 1110 may be networked. The one or more access device(s) 1110 may communicate with a remote server or other data storage and/or processing system. In an embodiment, a plurality of access devices 1110 may be grouped in rows, according to function. For example, one row of turnstiles or entry devices may accommodate paper tickets while another row of turnstiles, entry devices or scanners accommodates electronic identification or access cards.

The access device 1110 verifies authentication data to allow a ticket owner 1120 to access a venue 1130. The access device 1110 may accept a printed ticket, an access card, an identification card (such as a driver's license, state identification card, student ID, smart card, or membership card), a credit or debit card, a biometric identifier, a barcode, a magnetic strip, a wireless transmitter, a radio frequency identification device (RFID), an electronic key, or other such authentication/access data. The authentication data verifies that the bearer 1120 is allowed to access the venue 1130. The bearer 1120 may not necessarily be the original purchaser of admission to the event. In an embodiment, the access device 1110 is a multi-input access device. That is, the access device 1110 is capable of accepting one or more of the above methods of access authentication, for example.

In an embodiment, an access device 1110, such as a multi-input turnstile or any other entry device, accepts both paper and paperless tickets. A scanner or other detector on the access device 1110 verifies the authentication data and allows access to the venue 1130. A magnetic strip may be scanned to determine access, for example. A bar code may also be scanned to verify access. Alternatively, a picture or digitally encrypted facsimile of a ticket may be transmitted to the access device 1110 and displayed on a screen of the device 1110. A digital code may be sent to an interface on the access device 1110 to allow entry. A wireless or infrared link may be used to transmit the digital code to a receiver at the access device 1110. In another embodiment, a transmitter at the access device 1110 may transmit a pulse to an RFID device, which returns a response to authenticate the bearer 1120. Biometric data, such as a fingerprint, retinal scan, or voiceprint may also be used to authenticate an individual 1120 seeking access to a venue 1130. An electronic device, such as a handheld computer, personal digital assistant, cellular phone, or wireless transmitter may transmit a paperless ticket or access key to the access device 1110 for entry into a venue 630.

Verification of an individual for admission to a venue may be accomplished in a variety of ways. Thus, certain embodiments provide an access device that allows verification using a plurality of techniques. As venues transition from paper tickets to paperless tickets, certain embodiments accommodate paper tickets while also accepting forms of paperless entry, such as an electronic ticket. That is, certain embodiments may allow admission through surrender of a tangible item and/or with requiring surrender of a tangible item. In an embodiment, verification of a patron's seat may be generated in paper and/or paperless form upon access to the venue.

Certain embodiments provide a venue with new access devices, such as new turnstiles or other entry devices to allow access to the venue. Other embodiments provide a retrofit module to modify existing access devices, such as turnstiles, other entry devices or scanners, to accept paperless tickets and authentication data. In an embodiment, a retrofit system allows a turnstile or any entry device to communicate with an access computer system to allow admission to a venue using paperless and/or printed forms of authentication.

FIG. 12 illustrates a method 1200 for multi-input access to a venue used in accordance with an embodiment of the present invention. First, at step 1210, a patron approaches an access device. Then, at step 1220, the patron presents authentication data at the access device. The authentication data may be in the form of a paper ticket or may be paperless authentication data, such as a bar code, magnetic strip, biometric identifier, wireless transmitter, or other authentication data, for example. The patron may move to present the paper or paperless authentication data, or a detector at the access device may detect the authentication data on the patron.

Next, at step 1230, the authentication data is transmitted to a processing system, such as a processor at the access device or a verification computer located remotely from the access device. At step 1240, the processing system verifies that the authentication data allows the patron into the venue. For example, the processing system may compare the authentication data to entries in a database. Then, at step 1250, the patron is admitted or denied access to the venue based on a result returned by the processing system.

In an embodiment, before arriving at the venue, upon gaining access to the venue or after gaining access to the venue, a verification of the patron's access may be generated in paper and/or paperless form. In many venues or for many events, entrants to a venue must be able to produce verification of his or her particular seating location. Such verification or receipt may be used to confirm access to a certain section or tier in a venue or access to certain benefits or features of an event or venue, for example. The verification may be a printed receipt and/or a paperless verification of the patron's right of access. For example, paperless verification may be a bar code or magnetic encoding, a smart card, a wireless or infrared or other signal transmission, etc. In another embodiment, a patron's authentication may be entered into a database and verified via biometric identification, card identification, personal transmitter, encoded magnetic strip, and/or bar code, for example. In an embodiment, verification may be transmitted via email or facsimile to a patron prior to arrival at an event or venue, for example. The patron may then print the verification, for example.

The access verification/receipt may be generated by the access device, such as the turnstile or any entry device. Additionally, the verification/receipt may be generated by a transmitter, printer, kiosk or station inside or outside the venue. The verification/receipt may be transmitted, printed and/or encoded as described above. In an embodiment, a verification generation module or receipt unit, such as a turnstile, any entry device, computer, mobile device or standalone kiosk, for example, prints or uploads a receipt, ticket, or other access verification for a patron.

Thus, control may be maintained over a venue allowing paper-based and/or paperless tickets by providing a system for seating or access verification inside the venue. Through presentation of a paper receipt or paperless verification, an entrant's area or level of access may be confirmed by staff and/or electronic systems at the venue.

For example, the access device is a wireless handheld device, such as a personal digital assistant. Authentication data, such as a smart card, is used by a patron to gain access to a concert venue. Once inside the venue, the patron's smart code includes seat verification information. An usher or other staff member may use another handheld device, such as a wireless personal digital assistant, to scan the smart card to determine that the patron is allowed to sit in a certain section of the concert venue and/or a particular seat in the section.

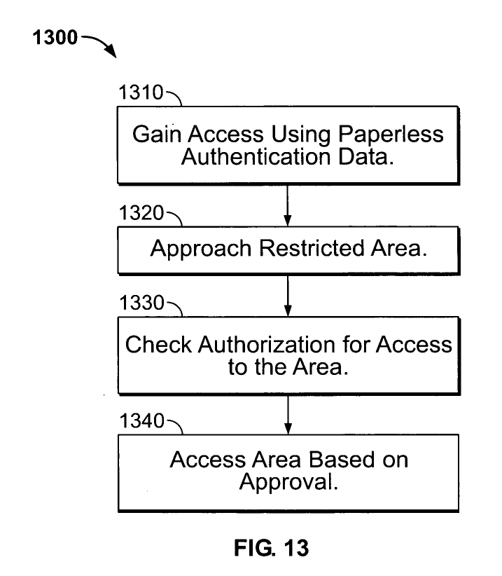

FIG. 13 illustrates a flow diagram for a method 1300 for access verification inside a venue in accordance with an embodiment of the present invention. First, at step 1310, a patron gains access to a venue using paperless authentication data. For example, a patron enters a stadium using that patron's credit card information. Then, at step 1320, the patron approaches an area of the venue to which access has been restricted to a certain group of patrons. For example, a patron bearing a ticket to a lower tier of a stadium walks to the appropriate seating section after entering the stadium.

Next, at step 1330, a staff member checks the patron's authorization for access to the area. For example, an usher with a handheld wireless device may scan the magnetic strip of the patron's credit card or otherwise verify that the patron is allowed to sit in the section of the stadium. That is, in order to regulate patron traffic and restrict access to certain areas, venue staff ensure that a patron is entitled to access a given area. Use of paperless seat verification eliminates the need for presentation of a paper ticket inside the venue. Alternatively, a paper ticket or seat verification may be generated at the venue, even if the patron used paperless authentication data to access the venue. Finally, at step 840, the patron accesses the area after approval by the staff member. Verification may be used to confirm access to a particular seat, a particular seating area, a particular event within the venue, and/or a particular service within the venue, for example.

Alternatively, an automated scanning system may check the patron's authorization and allow access. For example, a patron may have a transmitter, RFID device or other mobile device which broadcasts a signature when triggered by a scanner. A scanner at the venue verifies that the person bearing the signature is authorized to access the area and then allows the patron to proceed.

Thus, certain embodiments provide a system and method for managing an entire customer lifecycle. Certain embodiments capture original point-of-sale information when a ticket, such as an electronic or paper-based ticket is issued. Certain embodiments provide a system and method to monitor transactions and add-on revenue associated with the ticket. The use of electronic tickets and associated data facilitates a single, centralized system and method where buyers and sellers conduct business in a safe and secure location.

Certain embodiments provide for sale and/or auction of tickets on primary and secondary markets. Certain embodiments allow organizations to track information, such as buying patterns and attendance, and build customer relationships, additional revenue streams, and branding. Certain embodiments provide data regarding ticket information, inventory allocation, and customer actions. Certain embodiments allow organizations to control their product(s) and/or service(s) and gather information regarding their product(s) and/or service(s). Increased control and information may increase revenue generated from the product(s) and/or service(s). Certain embodiments improve organizational operation and management and help provide increased satisfaction to organizations and their customers.

Thus, certain embodiments provide a system and method for paperless ticket exchange. Certain embodiments allow paperless authentication data, such as biometric data, credit card or identification data, or transmission data to be used to access a venue. Certain embodiments provide a multi-use access device which accepts physical and/or non-physical authentication data to allow a bearer into a venue. Certain embodiments allow a verification of access to be generated for a patron. The verification may be used as a receipt and/or as verification of a right to access a particular feature and/or area at a venue.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for fan lifecycle management, said method comprising:
collecting information regarding a ticket for an event and a buyer of said ticket upon sale of said ticket; and
facilitating sale of at least one of products and services related to said event based on said information.

2. The method of claim 1, wherein said collecting step further comprises collecting information regarding a seller of said ticket.

3. The method of claim 1, further comprising verifying said information to provide access to said event for said buyer.

4. The method of claim 1, wherein said facilitating step further comprises facilitating sale of at least one of products and services at least one of before and after said event.

5. The method of claim 1, further comprising analyzing said information to generate a report or a recommendation regarding said event.

6. The method of claim 1, wherein said ticket comprises an electronic ticket.

7. The method of claim 1, wherein said collecting step further comprises electronically collecting information, and wherein said facilitating step further comprises electronically facilitating sale of at least one of said products and said services.

8. A system for fan lifecycle management, said system comprising:
a primary market configured to facilitate a sale of a ticket to a first buyer and recordation of first buyer and ticket information;
a secondary market exchange configured to facilitate exchange of said ticket between said first buyer and a second buyer and recordation of second buyer and ticket information; and
a value-added subsystem configured to provide at least one of products and services to at least one of said first buyer and said second buyer based on at least one of said first buyer information and said second buyer information.

9. The system of claim 8, wherein said system is associated with at least one of an organization and a venue.

10. The system of claim 8, further comprising a data center configured to store said ticket information, said first buyer information, and said second buyer information, wherein said data center facilitates analysis of said ticket information, said first buyer information, and said second buyer information.

11. The system of claim 8, further comprising an access subsystem capable of granting access to an event related to said ticket based on at least one of said first buyer information and said second buyer information.

12. The system of claim 11, wherein said access subsystem grants access to said event based on an electronic lookup of at least one of said first buyer information and said second buyer information.

13. The system of claim 8, wherein said system facilitates electronic issuance and exchange of paperless tickets.

14. The system of claim 8, wherein said value-added subsystem provides at least one of products and services to at least one of said first buyer and said second buyer before and after an event related to said ticket based on at least one of said first buyer information and said second buyer information.

15. The system of claim 8, further comprising an interface for accessing said system.

16. A computer-readable medium having a set of instructions for execution on a computer, said set of instructions comprising:
a ticketing routine configured to facilitate an exchange of a ticket on at least one of a primary market and a secondary market exchange, wherein said exchange includes acquisition of at least one of buyer information and seller information;
a services routine for providing at least one of products and services related to an event, based on said at least one of buyer information and seller information; and
an access routine for granting access to said event based on said buyer information.

17. The set of instructions of claim 16, wherein said service routine further provides at least one of products and services related to said event at least one of before said event and after said event, based on said at least one of buyer information and seller information.

18. The set of instructions of claim 16, wherein said ticketing routine is configured to facilitate electronic sale of said ticket, and wherein said access routine is configured to grant access to said event based on electronic verification of said buyer information.

19. The set of instructions of claim 16, further comprising an interface routine facilitating use of said ticketing routine and said services routine via a graphical user interface.

20. A fan lifecycle management system, said system comprising;
a data center including electronic data related to at least one of a ticket seller and a ticket buyer, wherein said data is used to facilitate electronic ticket sales, secondary market exchanges, sale of value-added products or services provided prior to an event, and sale of value-added products or services provided after an event.

21. The system of claim 20, wherein said data center extracts said electronic data related to at least one of ticket sellers and ticket buyers from primary market and secondary market exchange ticket transactions involving said ticket sellers and said ticket buyers.

22. The system of claim 20, wherein said value-added products or services comprise at least one of pre-paid parking, concessions, merchandise, travel arrangement, and ticket offers.

23. A method for data analysis related to event tickets, said method comprising:
collecting data related to a fan lifecycle management system, wherein said data relates to at least one of issuance and exchange for a ticket to an event; and
analyzing said data.

24. The method of claim 23, customizing at least one of a product and a service based on said analysis of said data.

25. A ticket exchange system, said system comprising:
a ticket issuance subsystem for issuing a ticket to a buyer;
a ticket exchange subsystem capable of facilitating an exchange of said ticket between a primary buyer and a secondary buyer; and
a value-added subsystem for providing at least one of value-added products and services based on information gathered from at least one of ticket issuance and ticket exchange.

26. The system of claim 25, further comprising a data analysis subsystem for analyzing said information gathered from at least one of ticket issuance and ticket exchange.

27. The system of claim 25, further comprising an entry subsystem configured to facilitate entry into a venue based on said ticket.

28. The system of claim 25, wherein said value-added subsystem provides at least one of products and services at least one of before and after an event.

29. A ticket exchange system comprising:
a graphical user interface enabling a user to access a ticket exchange to at least one of buy a ticket, bid on a ticket, sell a ticket, ask a price for a ticket, exchange a ticket, and pay for a ticket; and
a database including ticket-related information, said information gathered based on said access to said ticket exchange via said graphical user interface.
